(19) United States
(12) Patent Application Publication
(10) Pub. No.: US 2024/0375064 A1
(43) Pub. Date: Nov. 14, 2024

(54) Continuous Mixing Device And Related Method

(71) Applicants: L'AIR LIQUIDE SOCIETE ANONYME POUR L'ETUDE ET L'EXPLOITATION DES PROCEDES GEORGE, Paris (FR); AddUp, Cébazat (FR)

(72) Inventors: Stéphane Dudret, Jouy En Josas (FR); Coralie Charpentier, Saint Priest (FR); Sébastien Doublet, Bagneux (FR); Edouard Chauvet, Saint-Pierre Du Perray (FR); Kilian Bounouar, Saint-Pierre Du Perray (FR)

(73) Assignees: L'AIR LIQUIDE SOCIETE ANONYME POUR L'ETUDE ET L'EXPLOITATION DES PROCEDES GEORGE, Paris (FR); AddUp, Cébazat (FR)

(21) Appl. No.: 18/687,976

(22) PCT Filed: Sep. 1, 2022
(86) PCT No.: PCT/FR2022/051653

§ 371 Date: Feb. 29, 2024

(30) Foreign Application Priority Data
Sep. 1, 2021 (FR) 2109155

(51) Int. Cl. B01F 23/60; B01F 27/724; B01F 35/00; B01F 35/71

(52) U.S. Cl. CPC B01F 23/69; B01F 27/724; B01F 35/189; B01F 35/71731; B01F 35/71775

(57) ABSTRACT

A device for continuously mixing a first powder and a second powder, includes a first metering device for continuously metering the first powder, and a second metering device for continuously metering the second powder, a mixer designed to mix the first powder metered by the first metering device and the second powder metered by the second metering device so as to supply a continuous stream of powder mixed according to a determined ratio, and a sampling device designed to sample a fraction of the stream of mixed powder.

### FIELD OF THE INVENTION

The present innovation concerns the field of mixture of powders, for example of powders intended to be used in a manufacturing method.

The present innovation concerns in particular a mixing device, a system and a method associated thereto.

### STATE OF THE ART

Industrial processes using powders, for example metal powders, such as manufacturing methods are known. These processes include the additive manufacturing and the manufacturing of a part in one step by compaction then sintering. To successfully carry out such processes, the management of the powder is a crucial point. During the implementation of these processes, for example involving the manufacturing of a part, a certain number of phenomena can generate contaminations or modifications to the surrounding unused powder.

For example, during an additive manufacturing process, for example metal additive manufacturing process with selective laser melting (laser beam melting) called “powder bed” melting, the laser locally melts the powder bed. This interaction between the laser and the powder generates splashes and fumes into quantities similar to the laser welding methods. It is seen that once their maximum amplitude of ascent has been reached, the splashes formed by the interaction between the laser and the powder partly fall back onto the powder bed. The fumes can, for their part, cover and contaminate the splashes or the surrounding powder. These splashes and fumes are therefore sources of contamination of the metal powder, the splashes having a composition close to the initial powder, but generally over-oxidized, possibly with modifications to the alloy related to the volatilization of some elements during melting. In addition, unfused powder located in the vicinity of the fused areas can also undergo changes in the chemical composition due to a significant thermal effect related to the proximity of the area melted by the laser.

During the implementation of the processes, part of the powder is not used, for example not fused, and can be recycled that is to say reused during further implementations of the process, to reduce costs related to the raw material. This recycled powder differs from the new powder in that it changes and is loaded, along the iterations of the processes, with products such as oxides, splashes, and fumes in the case of metal additive manufacturing with selective laser melting. Furthermore, during the handling of the powders subsequently to the implementation of the process, this powder can also be contaminated by the surrounding atmosphere, and thus loaded for example with oxygen and/or humidity. The recycled powder can thus be mixed with a new powder, that is to say a powder that has not yet been used within the framework of the process.

Apart from the recycling cases, different powders can also be mixed to obtain a mixed powder having a desired property, such as a certain content of a defined element, for example an oxygen content, or a specific average particle size, or an average composition.

Mixing devices are known. For example, a batch-mixing method, that is to say directly stirring all of the raw materials for example all of the batches of powder at the same time, is known. Among other disadvantages, the associated systems require high-power actuators to set the stirring mechanisms in motion, which can also damage the powders. In addition to a significant material cost, the implementation of these high energies leads to high electricity consumption and, where applicable, significant risks related to the explosiveness of the powders. Thus, it is both expensive and complex to obtain a functional motor in its conditions, which must have a significant volume and power, and compatible with the operational safety requirements in an explosive environment.

### DISCLOSURE OF THE INVENTION

One aim of the invention is to resolve at least one of these drawbacks. One aim of the invention is particularly to obtain quality powder mixtures in an efficient and secure manner.

For this purpose, a device for continuously mixing a first powder and a second powder is proposed, characterized in that the device comprises:
a first continuous dosing apparatus of the first powder and a second continuous dosing apparatus of the second powder,
a mixer arranged to mix the first powder dosed by the first dosing apparatus and the second powder dosed by the second dosing apparatus so as to provide a continuous stream of powder mixed according to a determined ratio, and
a sampler adapted to take a fraction of the stream of mixed powder.

The device can comprise the following characteristics, taken alone or in any one of their technically possible combinations:
the first dosing apparatus is a gravimetric dosing apparatus and/or the second dosing apparatus is a gravimetric dosing apparatus;
the first dosing apparatus is a screw dosing apparatus and/or the second dosing apparatus is a screw dosing apparatus and/or the mixer is a screw mixer and/or the sampler is a screw sampler;
a first reservoir for the first powder arranged to store the first powder and to continuously provide the first powder to the first dosing apparatus, for example by gravity, and/or a second reservoir for the second powder arranged to store the second powder and to continuously provide the second powder to the second dosing apparatus, for example by gravity, and/or a third reservoir for the mixed powder arranged to receive the stream of mixed powder;
the device is configured to track the first stored powder and/or the second stored powder and/or the stored mixed powder;
a powder and gas-tight flexible fluid connection element between the first reservoir and the first dosing apparatus and/or a powder and gas-tight flexible fluid connection element between the second reservoir and the second dosing apparatus and/or or a powder and gas-tight flexible fluid connection element between the first dosing apparatus and the mixer and/or a powder and gas-tight flexible fluid connection element between the second dosing apparatus and the mixer, and/or a powder and gas-tight flexible fluid connection element between the mixer and the third reservoir;
inerting means adapted to distribute an inerting gas at one or more points of the device, and adapted to collect the inerting gas at one or more points of the device;
the inerting means are adapted to, for example selectively, distribute the inerting gas to the, and collect the inerting gas from, the first reservoir and/or second reservoir and/or second reservoir and/or first dosing apparatus and/or second dosing apparatus and/or mixer and/or sampler, and/or powder and gas-tight fluid connection means between the first reservoir and the first dosing apparatus and/or powder and gas-tight fluid connection means between the second reservoir and the second dosing apparatus and/or powder and gas-tight fluid connection means between the first dosing apparatus and the mixer and/or powder and gas-tight fluid connection means between the second dosing apparatus and the mixer, and/or powder and gas-tight fluid connection means between the mixer and the third reservoir; and
the mixed powder is intended for additive manufacturing, one at least of the first powder and of the second powder being a recycled powder.

A method for obtaining a mixed powder is further proposed, implemented by means of such a device, the method comprising the continuous mixing of the first powder and of the second powder.

### DESCRIPTION OF THE FIGURES

Other characteristics, aims and advantages of the invention will emerge from the following description, which is purely illustrative and not limiting, and which should be read in relation to the appended drawings in which:

FIG. 1 schematically illustrates a mixing device according to one exemplary embodiment of the invention;

FIG. 2 schematically illustrates in more detail some elements of the device of FIG. 1;

FIG. 3 schematically illustrates in more detail some elements of the device of FIG. 1;

FIG. 4 schematically illustrates the dosing apparatuses of the device of FIG. 1;

FIG. 5 schematically illustrates a mixer of the device of FIG. 1;

FIG. 6 schematically illustrates a sampler of the device of FIG. 1;

FIG. 7 schematically illustrates control means of the device of FIG. 1;

FIG. 8 schematically illustrates inerting gas distribution means of the device of FIG. 1;

FIG. 9a schematically illustrates inerting gas collection means of the device of FIG. 1;

FIG. 9b schematically illustrates an alternative configuration of the inerting gas collection means of the device of FIG. 1;

FIG. 10 schematically illustrates inerting gas expansion means of the device of FIG. 1;

FIG. 11 schematically illustrates a sub-assembly of the distribution means of FIG. 8;

FIG. 12a schematically illustrates a sub-assembly of the collection means of FIG. 9a or FIG. 9b;

FIG. 12b schematically illustrates a configuration of the sub-assembly of the collection means of FIG. 12a;

FIG. 12c schematically illustrates another configuration of the sub-assembly of the collection means of FIG. 12a;

FIG. 12d schematically illustrates another configuration of the sub-assembly of the collection means of FIG. 12a;

FIG. 13 is a side view of a device according to another exemplary embodiment of the invention;

FIG. 14 is a view from another side of the device of FIG. 13;

FIG. 15 is a view from above of a detail of the device of FIG. 13;

FIG. 16 is a view of another detail of the device of FIG. 13;

FIG. 17 is a flowchart of steps of a method for obtaining a mixed powder according to one exemplary embodiment of the invention;

FIG. 18a is a diagram representing the implementation of steps of the obtaining method of FIG. 17 over time;

FIG. 18b is another diagram representing the implementation of steps of the obtaining method of FIG. 17 over time;

FIG. 18c is another diagram representing the implementation of the method for replacing the mixed powder obtaining method of FIG. 17 over time.

In all the figures, similar elements bear identical references.

### DETAILED DESCRIPTION OF THE INVENTION

### General Description of the Device

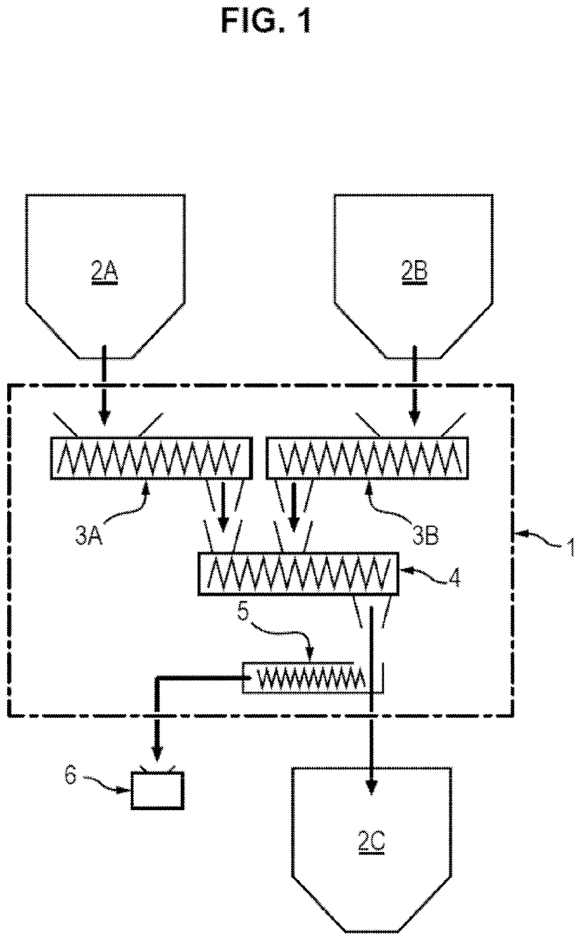

With reference to FIGS. 1 to 16, a device for mixing a first powder and a second powder is described. The mixing device can be a continuous mixing device. By “continuous”, it is meant for example that the device operates continuously with streams of powders, as opposed to a batch mixture where all of the powder is mixed at the same time. The mixing device comprises a mixing assembly 1 which comprises a first dosing apparatus 3A for the first powder. The first dosing apparatus 3A can be a continuous dosing apparatus. The device comprises a second dosing apparatus 3B for the second powder. The second dosing apparatus 3B can be a continuous dosing apparatus.

The mixing device comprises a mixer 4. The mixer 4 is arranged to mix the first powder dosed by the first dosing apparatus 3A and the second powder dosed by the second dosing apparatus 3B, so as to provide a continuous stream of mixed powder. The stream can be provided according to a determined ratio, for example depending on the first dosing apparatus 3A and on the second dosing apparatus 3B. The mixing device comprises a sampler 5 adapted to take a fraction of the stream of mixed powder. The mixing device allows making a homogeneous mixture, that is to say without segregation, or with limited segregation, by density, by composition or by particle size in the final mixed product, of two powders, while meeting throughout the mixing operation a ratio of the proportions, for example mass proportions, of the powders mixed in the final product, by protecting them more easily from contamination by the external atmosphere, by more easily protecting the operators from exposure to the powders, by more easily preventing the risks linked to the possible formation of an explosive atmosphere through the suspension of powder particles, and by allowing the traceability of the operation, in particular through the sampling of the mixed powder during its production. The mixing device can thus form a dosing apparatus-mixer.

### Reservoir(s)

The mixing device can be adapted to store the first powder and/or the second powder and/or the mixed powder. The mixing device can further comprise a first reservoir 2A for the first powder, the first reservoir 2A being arranged to store the first powder and/or to continuously provide the first powder to the first dosing apparatus 3A, for example by gravity. The first reservoir 2A can store the first powder. The first powder can be a new powder, that is to say not derived from a material recycling method. The device can comprise a second reservoir 2B for the second powder, the second reservoir 2B being arranged to store the second powder and/or to continuously provide the second powder to the second dosing apparatus 3B, for example by gravity. The second reservoir 2B can store a second powder. The second powder can be a recycled powder, that is to say derived from a material recycling method. The mixing device can comprise a third reservoir 2C for the mixed powder, the third reservoir 2C being arranged to receive the stream of mixed powder. The third reservoir 2C can be arranged to continuously receive, for example by gravity, the mixed powder derived from the mixer 4. The third reservoir 2C can store a mixed powder.

The first reservoir 2A and/or the second reservoir 2B and/or the third reservoir 2C can comprise a hopper, for example an inerted hopper, for example via inerting means as described below. By “inerted”, it is meant for example whose internal atmosphere has been replaced by a gas or a mixture of dry and neutral gas, that is to say not chemically reacting with the element stored or intended to be disposed within the internal atmosphere, for example with the first powder and/or the second powder and/or the mixed powder. The dry and neutral gas can be or comprise argon.

The first reservoir 2A, respectively the second reservoir 2B, can be connected to the dosing apparatus 3A, respectively 3B. The first reservoir 2A and/or the second reservoir 2B and/or the third reservoir 2C can each comprise means for storing state data of the corresponding stored powder and/or the atmosphere inside the corresponding reservoir, for example the first reservoir 2A or the second reservoir 2B or the third reservoir 2C.

The first reservoir 2A and/or the second reservoir 2B and/or the third reservoir 2C can be removable. The first reservoir 2A and/or the second reservoir 2B and/or the third reservoir 2C can for example be detached from the device, for example to be transported. The first reservoir 2A and the second reservoir 2B, and/or the first reservoir 2A and the third reservoir 2C and/or the second reservoir 2B and the third reservoir 2C can be identical and/or interchangeable.

The first reservoir 2A can comprise a first outlet duct 17A for the first powder, for example a rigid duct. The first outlet duct 17A can comprise a first outlet valve 20A. The first outlet valve 20A can be a butterfly valve. The first reservoir 2A can comprise a first inlet duct 26A for the first powder, for example a rigid duct. The first inlet duct 26A can comprise a first inlet valve 27A. The first inlet valve 27A can be a butterfly valve.

The second reservoir 2B can comprise a second outlet duct 17B for the second powder, for example a rigid duct. The second outlet duct 17B can comprise a second outlet valve 20B. The second outlet valve 20B can be a butterfly valve. The second reservoir 2B can comprise a second inlet duct 26B for the second powder, for example a rigid duct. The second inlet duct 26B can comprise a second inlet valve 27B. The second inlet valve 27B can be a butterfly valve.

The third reservoir 2C can comprise a third outlet duct 17C for the third powder, for example a rigid duct. The third outlet duct 17C can comprise a third outlet valve 20C. The third outlet valve 20C can be a butterfly valve. The third reservoir 2C can comprise a third inlet duct 26C for the third powder, for example a rigid duct. The third inlet duct 26C can comprise a third inlet valve 27C. The third inlet valve 27C can be a butterfly valve.

### Dosing Apparatus(es)

The first dosing apparatus 3A allows dosing, for example discharging a determined quantity and/or mass of the first powder, for example derived from the first reservoir 2A, independently of the second powder and/or of the second dosing apparatus 3B and/or of the second reservoir 2B. The first dosing apparatus 3A allows dosing, for example discharging the determined quantity and/or mass of the first powder, for example derived from the first reservoir 2A, independently of the downstream of the device. The second dosing apparatus 3B allows dosing, for example discharging a determined quantity and/or mass of the second powder, for example from the second reservoir 2B, independently of the first powder and/or of the first dosing apparatus 3A and/or of the first reservoir 2A. The second dosing apparatus 3B allows dosing, for example discharging the determined quantity and/or mass of the second powder, for example derived from the second reservoir 2B, independently of the downstream of the device.

The first reservoir 2A and the first dosing apparatus 3A are arranged to allow the continuous discharge of the first powder from the first reservoir 2A into the mixer 4 and/or the second reservoir 2B and the second dosing apparatus 3B are arranged to allow the continuous discharge of the second powder from the second reservoir 2B into the mixer 4, for example by gravity.

By “independent dosing”, it is meant that the dosing as such is carried out independently. The commands of different independent actions and/or parts can however be correlated. By “upstream”, respectively “downstream”, it is meant upstream, respectively downstream, depending on the direction of flow of the powder in the device, for example in the direction going from the first or second reservoir to the first or second dosing apparatus, from the first or second dosing apparatus to the mixer. To allow the monitoring of the determined quantity and/or mass of the first powder, respectively of the second powder, the device can be configured to allow the continuous weighing of the first powder, respectively the second powder. The weighing can be carried out by means of a prior calibration when empty and/or of a differential weighing operation for eliminating the influence of dead masses to dose the pouring of the first powder, respectively of the second powder.

The first dosing apparatus 3A can be a gravimetric dosing apparatus and/or the second dosing apparatus 3B can be a gravimetric dosing apparatus, for example continuous gravimetric dosing apparatus(es) by weight loss. The first dosing apparatus 3A and/or the second dosing apparatus 3B can thus continuously regulate a dosing apparatus speed as a function of weight loss to obtain a flow rate, for example a determined constant flow rate, for example determined by a command. The first dosing apparatus 3A and/or the second dosing apparatus 3B thus make it possible to convey the first and/or the second powder to the mixer 4 at a regulated flow rate, for example in kg/h, and thus dose the quantity of first powder and/or second powder conveyed to the mixer 4. The first dosing apparatus 3A can comprise a first helical powder drive means and/or the second dosing apparatus 3B can comprise a second helical powder drive means. The first dosing apparatus 3A can thus be a gravimetric screw dosing apparatus and/or the second dosing apparatus 3B can thus be a gravimetric screw dosing apparatus. The first dosing apparatus 3A and/or the second dosing apparatus 3B can lead to the mixer 4.

As illustrated in FIG. 4, the first dosing apparatus 3A can comprise a first dosing apparatus body 38A. The first dosing apparatus body 38A can comprise a first inlet duct 14A for the first powder, for example a rigid duct. The first inlet duct 14A can comprise a first upstream valve 19A. The first dosing apparatus body 38A can comprise a first outlet duct 39A for the first powder.

The first helical powder drive means can comprise a first screw 40A, for example a worm screw. The first screw 40A can be disposed inside the first dosing apparatus body 38A, for example in a first central cylindrical duct formed by the first dosing apparatus body 38A, for example between the first inlet duct 14A and the first outlet duct 39A. The first dosing apparatus body 38A can comprise a first motor group 41A. The first motor group 41A can be electric. The first motor group 41A can be arranged to rotate the first screw 40A. The first motor group 41A can be disengageable, that is to say movable, to allow its withdrawal, and thus allow access and dismounting of the first screw 40A, for example to replace it, and/or cleaning of the interior the first dosing apparatus 3A. The first motor group 41A can be pivotable around a hinge 42A; it is thus possible to maintain a mechanical support even in the disengaged phase.

The first motor group 41A can be abuttable to the first dosing apparatus body 38A, for example in a sealed manner. The first screw 40A can be hollow, that is to say for example comprise a thread without a support body over the entire length of the thread, so as to be reduced for example to a turn or a ribbon or comprise, over all or part of its length, a first central hub 43A.

As illustrated in FIG. 4, the second dosing apparatus 3B can comprise a second dosing apparatus body 38B. The second dosing apparatus body 38B can comprise a second inlet duct 14B for the second powder, for example a rigid duct. The second inlet duct 14B can comprise a second upstream valve 19B. The second dosing apparatus body 38B can comprise a second outlet duct 39B for the second powder.

The second helical powder drive means can comprise a second screw 40B, for example a worm screw. The second screw 40B can be disposed inside the second dosing apparatus body 38B, for example in a second central cylindrical duct formed by the first dosing apparatus body 38A, for example between the first inlet duct 14A and the first outlet duct 39A. The second dosing apparatus body 38B can comprise a second motor group 41B. The second motor group 41B can be electric. The second motor group 41B can be arranged to rotate the second screw 40B. The second motor group 41B can be disengageable, that is to say movable, to allow its withdrawal, and thus allow access and dismounting of the second screw 40B, for example to replace it, and/or cleaning of the interior of the second dosing apparatus 3B. The second motor group 41B can be pivotable around a hinge 42B; it is thus possible to maintain a mechanical support even in the disengaged phase. The second motor group 41B can be abuttable to the body 38B of the second dosing apparatus, for example in a sealed manner. The second screw 40B can be hollow, that is to say for example comprise a thread without a support body over the entire length of the thread, so as to be reduced for example to a turn or a ribbon or comprise, over all or part of its length, a second central hub 43B.

The first dosing apparatus 3A and the first dosing apparatus 3B can be different. For example, the first dosing apparatus 3A can be a Parimix DMR391 dosing apparatus and/or can be configured to provide regulated flow rates from 7 to 50 liters per hour of a first powder of apparent 1 to 4 density by means of the first motor group 41A of 0.25 kW power; the second dosing apparatus 3B can be a Parimix DMR531 dosing apparatus and/or configured to provide regulated flow rates from 40 to 250 liters per hour of a second powder of apparent 1 to 4 density, by means of a second motor group 41B of 0.37 kW power. Alternatively, the first dosing apparatus 3A and the first dosing apparatus 3B can be identical.

### Mixer

The mixer 4 can be a continuous mixer. The mixer 4 allows obtaining the mixed powder in the form of a homogeneous mixture between the first powder and the second powder. The mixer 4 allows the continuous progression of the gradually mixed powder towards the third reservoir 2C.

The mixer 4 can comprise a motor. The mixer 4 can comprise a variable frequency drive, the variable frequency drive being arranged to drive the motor of the mixer, for example according to a configurable frequency setpoint. The mixer 4 can comprise a third helical powder drive means. The mixer 4 can be a screw mixer.

The mixer 4 can comprise a back pressure element 52. The back pressure element 52 can be a back pressure cylinder. The back pressure element 52 can be disposed downstream of the third helical drive means and/or of the cylindrical duct of the mixer 4. The back pressure element 52 can be arranged to exert a back pressure, for example towards the outlet of the mixer, for example at the outlet of the duct, and in a direction opposite to said outlet of the mixer and/or of the duct. The pressure can be less than 1 bar, for example greater than 0 bar. The back pressure element 52 can be arranged to optimize the homogeneity of the mixture. The mixer can comprise a valve, for example a proportional valve, arranged to allow the regulation of the pressure exerted by the back pressure element 52, for example according to a configurable pressure setpoint. The back pressure can be directed in the axis of the mixer 4, for example of the screw of the mixer, in the opposite direction to that of the progression of the powder, therefore directed from downstream to upstream. The back pressure element 52 can thus form a shutter for the outlet of the mixer 4; for example, the powder driven for example by the screw, must move back the back pressure element 52, thus causing a back pressure, to create a pathway towards the outlet of the mixer 4.

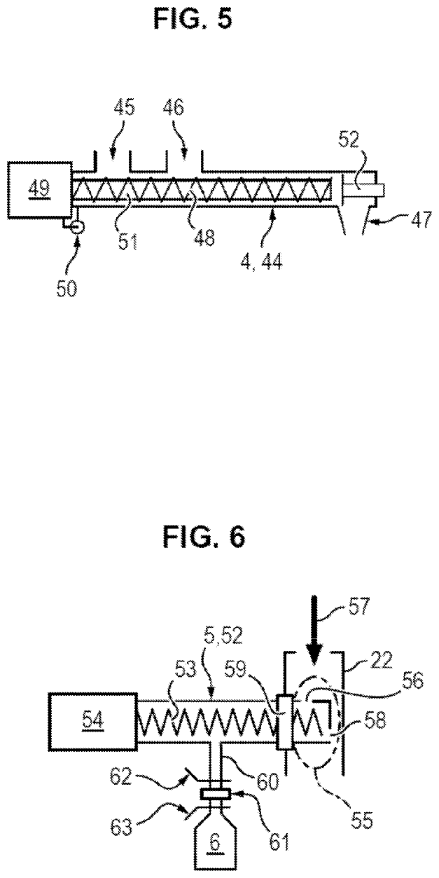

As illustrated in FIG. 5, the mixer 4 can comprise a mixer body 44. The mixer body 44 can comprise a first mixer inlet duct 45 and/or a second mixer inlet duct 46 and/or a mixer outlet duct 47. The mixer outlet duct 47 allows the continuous discharge of the mixed powder towards the sampler 5 and/or the third reservoir 2C.

The third helical powder drive means can comprise a third screw 48, for example a worm screw. The third screw 48 can be disposed inside the mixer body 44, for example in a third central cylindrical duct formed by the mixer body 44, for example between the first mixer inlet duct 45 and/or the second mixer inlet duct 46 and the mixer outlet duct 47. The mixer body 44 can comprise a third motor group 49. The third motor group 49 can be electric. The third motor group 49 can be arranged to rotate the third screw 48. The third motor group 49 can be disengageable, that is to say movable, to allow its withdrawal, and thus allow access and dismounting of the third screw 48, for example to replace it, and/or cleaning of the interior of the mixer 4. The third motor group 49 can be pivotable around a hinge 50. The third motor group 49 can be abuttable to the mixer body 44, for example in a sealed manner. The third screw 48 can be hollow, that is to say for example comprise a thread without a support body over the entire length of the thread, so as to be reduced for example to a turn or a ribbon, or comprise over all or part of its length a third central hub 51. In the extension of the third screw 48, for example on the side opposite to the third motor group 49, the back pressure element 52 can be arranged to oppose an adjustable force to the progression of the powder driven by the third screw 48 towards the mixer outlet duct 47.

The mixer 4 can be for example a Parimix MM53 mixer and/or the third motor group 49 can have a power of 1.5 kW.

### Sampler

The sampler 5 can be disposed downstream of the mixer 4 and/or upstream of the third reservoir 2C. The sampler 5 allows the ad hoc interception of at least part or a fraction of the stream 57 of the mixed powder derived from the mixer 4, for example between the mixer 4 and the third reservoir 2C. The sampler 5 allows the ad hoc sampling, for example during interception, of a quantity of mixed powder derived from the mixer 4.

As illustrated in FIG. 6, the sampler 5 can comprise a sampling head 55. The head 55 can comprise an inlet 56 for the interception of the mixed powder, for example comprising an inlet opening. The head 55 can comprise an outlet 58 for the reintroduction of the mixed powder, for example in the third upstream duct 22 as described below, for example to the third reservoir 2C, comprising for example a reintroduction outlet opening. The head 55 can be inserted and/or held in the fluid connection means between the mixer 4 and the third reservoir 2C as described below, for example in the third upstream duct 22 as described below, for example in a sealed manner and/or by allowing the dismounting of the sampler 5, for example as described below. The sampler 5 can comprise a flange 59 configured to allow the insertion and the holding of the head 55 in the fluid connection means between the mixer 4 and the third reservoir 2C.

The sampler 5 can comprise a sample container 6, for example a removable container. The sampler 5 can be adapted to discharge the or each quantity of powder taken into the container 6. It is thus possible to subsequently carry out analyzes of the characteristics of the taken powder.

The sampler 5 can comprise a fourth helical powder sampling drive means. The sampler 5 can be a screw sampler.

The sampler 5 allows obtaining a representative sample of an entire batch of the mixed powder, for example in order to monitor the compliance of the batch with predetermined specifications. The compliance can for example comprise a compliance in terms of contamination by chemical species, for example chemical species such as oxygen and/or hydrogen and/or nitrogen, and/or compliance in terms of particle size distribution.

The sampler 5 can comprise a sampler body 52. The sampler body 52 can comprise the sampling head 55.

The fourth helical powder drive means can comprise a fourth screw 53, for example a worm screw. The fourth screw 53 can be disposed inside the sampler body 52, for example in a fourth central cylindrical duct formed by the sampler body 52. The sampler body 52 can comprise a fourth motor group 54. The fourth motor group 54 can be electric. The fourth motor group 54 can be arranged to rotate the fourth screw 53. The fourth motor group 54 can be disengageable, that is to say movable to allow its withdrawal, and thus allow access and dismounting of the fourth screw 54, for example to replace it, and/or cleaning of the interior of the sampler 5. The fourth motor group 54 can be pivotable around a hinge or abutted to one end of the mixer, for example to the screw, without using a hinge. The fourth motor group 54 can be abuttable to the sampler body 52, for example in a sealed manner. The fourth screw 54 can be hollow or comprise over all or part of its length a fourth central hub.

The sampler body 52 can comprise a sampling outlet 60. The sampling outlet 60 can be arranged to allow discharging the mixed powder taken from the container 6. The sampling outlet 60 can comprise a sampling outlet duct. The sampler 5 can comprise a connector 61 arranged to fix the container 6, for example in a removable and/or sealed manner, to the sampler 5, for example to the sampling outlet 60, for example to the sampling outlet duct. The sampling outlet 60 can comprise a sampling outlet valve 62, for example mounted on the sampling outlet duct. The container 6 can comprise a closing device 63, for example a valve. The connector 61 can be disposed downstream of the sampling outlet valve 62 mounted on the sampler 5, and/or upstream of the closing device 63 of the container 6, for example in order to selectively preserve the sealing of the sampler 5 and of the container 6 when they are separated and in order to selectively put the sampler and their container in fluid communication.

The fourth screw 53 can be configured to rotate, in a sampling phase, in a first direction in order to convey the mixed powder intercepted by the interception inlet 56, towards the sampling outlet 60, so as to discharge the mixed powder intercepted in the container 6. The fourth screw 53 can be configured to rotate, in a purging phase, in a second direction, for example opposite to the first direction, in order to release any remainder of intercepted mixed powder remaining in the sampler body 52 through the mixed powder reintroduction outlet 58.

The sampler 5 can for example be a POWH-2N sampler from the company Labocontrole.

### Fluid Connection Means

### General Description

The device can comprise powder and gas-tight fluid connection means between the first reservoir 2A and the first dosing apparatus 3A and/or powder and gas-tight fluid connection means between the second reservoir 2B and the second dosing apparatus. 3B and/or powder and gas-tight fluid connection means between the first dosing apparatus 3A and the mixer 4 and/or powder and gas-tight fluid connection means between the second dosing apparatus 3B and the mixer 4, and/or powder and gas-tight fluid connection means between the mixer 4 and the third reservoir 2C.

### Fluid Connection Means Between the First Reservoir and the First Dosing Apparatus

The fluid connection means between the first reservoir 2A and the first dosing apparatus 3A can comprise a first upstream valve 19A. The first upstream valve 19A can be one or more butterfly valves. The fluid connection means between the first reservoir 2A and the first dosing apparatus 3A can comprise a first flexible fluid connection element 15A, for example a flexible sleeve. By “flexible”, it is meant for example having a bending capacity implemented so that a bending force exerted thereon is transferred to either of the ends. The first flexible fluid connection element 15A can be disposed downstream of the first outlet valve 20A and/or upstream of the first upstream valve 19A. The first flexible fluid connection element 15A can fluidly connect the first outlet valve 20A and the first upstream valve 19A. The first powder inlet duct 14A of the first dosing apparatus 3A can be extended upstream by the first flexible fluid connection element 15A.

The fluid connection means between the first reservoir 2A and the first dosing apparatus 3A can comprise a first rigid part 16A and/or a first flange 18A, disposed upstream of the first flexible fluid connection element 15A. The first rigid part 16A can extend the first flexible fluid connection element 15A upstream. The first rigid part 16A can form a duct. The fluid connection means between the first reservoir 2A and the first dosing apparatus 3A, for example the first rigid part 16A, can be fluidly connected in a sealed manner to the first outlet duct 17A of the first reservoir 2A, by means of the second flange 18A.

The flexibility of the first flexible fluid connection element 15A and/or of the second flexible fluid connection element 15B and/or of the third flexible fluid connection element 23, as described below, facilitates the connections between the first reservoir 2A and/or the second reservoir 2B and/or the third reservoir 2C, and of the dosing-mixing elements of the device, such as the first dosing apparatus 3A and/or the second dosing apparatus 3B and/or the mixer 4, in particular the correction of the alignment errors of the mechanical parts during the deposition of the first reservoir 2A and/or of the second reservoir 2B and/or of the third reservoir 2C, for example respectively on a first cradle 12A, second cradle 12B, and/or third cradle 12C, as described below.

### Fluid Connection Means Between the Second Reservoir and the Second Dosing Apparatus

The fluid connection means between the second reservoir 2B and the second dosing apparatus 3B can comprise a valve, for example a second upstream valve 19B. The second upstream valve 19B can be one or more butterfly valve(s). The fluid connection means between the second reservoir 2B and the second dosing apparatus 3B can comprise a second flexible fluid connection element 15B, for example a flexible sleeve. By “flexible”, it is meant for example having a bending capacity implemented so that a bending force exerted thereon is transferred to either of the ends. The second flexible fluid connection element 15B can be disposed downstream of the second outlet valve 20B and/or upstream of the second upstream valve 19B. The second flexible fluid connection element 15B can fluidly connect the second outlet valve 20B and the second upstream valve 19B. The second powder inlet duct 14B of the second dosing apparatus 3B can be extended upstream by the second flexible fluid connection element 15B. The fluid connection means between the second reservoir 2B and the second dosing apparatus 3B can comprise a second rigid part 16B and/or a second flange 18B, disposed upstream of the second flexible fluid connection element 15B. The second rigid part 16B can extend the second flexible fluid connection element 15B upstream. The second rigid part 16B can form a duct. The fluid connection means between the second reservoir 2B and the second dosing apparatus 3B, for example the second rigid part 16B, can be fluidly connected in a sealed manner to the second outlet duct 17B of the second reservoir 2B, by means of the second flange 18B.

### Fluid Connection Means Between the First Dosing Apparatus and the Mixer

The powder and gas-tight fluid connection means between the first dosing apparatus 3A and the mixer 4 can comprise a fourth fluid connection element 21A, for example a flexible element. By “flexible”, it is meant for example that in the event of deformation at one end, there is no or very little elastic tension that would be reflected at another end. It is thus possible for example to decouple the mixer and the first dosing apparatus 3A from the weighing point of view, because the weight of the first dosing apparatus 3A does not bear on the mixer 4 and vice versa. The fourth fluid connection element 21A can comprise a flexible sleeve or a bellows. The fourth fluid connection element 21A can fluidly connect the first outlet duct 39A of the first dosing apparatus 3A and the first mixer inlet duct 45. The fourth fluid connection element 21A can be arranged so that the weight of the elements of the device upstream of the mixer 4 is not transferred to the mixer 4, and therefore particularly the weight of the reservoir 2A and of the dosing apparatus 3A is entirely supported by the first weighing means, particularly supported by the first weighing cell(s) 11A of the first reservoir 2A as described below. The fourth fluid connection element 21A can be arranged so that the weight of the mixer 4, and for example of the content of the mixer and/or of the element(s) of the device downstream of the mixer 4, is not transferred to the first weighing means, particularly is not transferred to the first weighing cell(s) 11A of the first reservoir 2A as described below. This makes it possible to limit on what the weighing bears, and therefore to obtain a more accurate weighing. For this, the fourth fluid connection element 21A can be adapted to work in compression, for example in a reversible manner, for example so as to allow relative displacement of the downstream and upstream of the fourth fluid connection element 21A without weight transfer. Thus, the first weighing means measure the weight of the first reservoir 2A and/or of the first dosing apparatus 3A and/or of the fluid connection means between the first reservoir 2A and the first dosing apparatus 3A, for example the elements 14A, and/or 15A, and/or 16A, and/or 18A, and/or 19A, for example including their content, for example the first contained powder.

### Fluid Connection Means Between the Second Dosing Apparatus and the Mixer

The powder and gas-tight fluid connection means between the second dosing apparatus 3B and the mixer 4 can comprise a fifth fluid connection element 21B, for example a flexible element. By “flexible”, it is meant for example that in the event of deformation at one end, there is no or very little elastic tension that would be reflected at another end. It is thus possible for example to decouple the mixer 4 and the second dosing apparatus 3B from the weighing point of view, because the weight of the second dosing apparatus 3B does not bear on the mixer 4 and vice versa. The fifth fluid connection element 21B can comprise a flexible sleeve or a bellows. The fifth fluid connection element 21B can fluidly connect the second outlet duct 39B of the second dosing apparatus 3B and the second mixer inlet duct 46. The fifth fluid connection element 21B can be arranged so that the weight of the elements of the device upstream of the mixer 4 is not transferred to the mixer 4, particularly the weight of the reservoir 2B and of the dosing apparatus 3B is entirely supported by the second weighing means, particularly supported by the second weighing cell(s) 11B of the second reservoir 2B as described below. This makes it possible to limit on what the weighing bears, and therefore to obtain a more accurate weighing. The fifth fluid connection element 21B can be arranged so that the weight of the mixer 4, and for example of the content of the mixer and/or of the element(s) of the device downstream of the mixer 4, is not transferred to the second weighing means, particularly is not transferred to the second weighing cell(s) 11B of the second reservoir 2B as described below. For that, the fifth fluid connection element 21B can be adapted to work in compression, for example in a reversible manner, for example so as to allow relative displacement of the downstream and upstream of the fifth fluid connection element 21B without weight transfer. Thus, the second weighing means measure the weight of the second reservoir 2B and/or of the second dosing apparatus 3B and/or of the fluid connection means between the second reservoir 2B and the second dosing apparatus 3B, for example the elements 14B, and/or 15B, and/or 16B, and/or 18B, and/or 19B, for example including their content, for example the second contained powder.

### Fluid Connection Means Between the Mixer and the Third Reservoir

The powder and gas-tight fluid connection means between the mixer 4 and the third reservoir 2C can comprise a valve, for example a third upstream valve 28. The third upstream valve 28 can be a butterfly valve. The fluid connection means between the mixer 4 and the third reservoir 2C can comprise a third flexible fluid connection element 23, for example a flexible sleeve. By “flexible”, it is meant for example having a bending capacity implemented so that a bending force exerted thereon is transferred to either of the ends. The third flexible fluid connection element 23 can be disposed downstream of the third upstream valve 28 and/or upstream of the third inlet valve 27C. The third flexible fluid connection element 23 can fluidly connect the third upstream valve 28 and the third inlet valve 27C.

The fluid connection means between the mixer 4 and the third reservoir 2C can comprise a third upstream duct 22, for example a rigid duct, allowing the supply of mixed powder from the mixer 4. The mixer 4 can discharge the mixed powder into the third upstream duct 22 via the outlet duct 47 of the mixer. The third upstream duct 22 can comprise the third upstream valve 28. The third upstream duct 22 can be extended downstream by the third flexible fluid connection element 23.

The fluid connection means between the mixer 4 and the third reservoir 2C can comprise a third rigid part 24 and/or a third flange 25, disposed downstream of the third flexible fluid connection element 23. The third rigid part 24 can extend the third flexible fluid connection element 23 downstream. The third rigid part 24 can form a duct. The fluid connection means between the mixer 4 and the third reservoir 2C, for example the third rigid part 24, can be fluidly connected in a sealed manner to the third inlet duct 26C of the third reservoir 2C, by means of the third flange 25.

### Through Visualization

The first flexible fluid connection element 15A, and/or the second flexible fluid connection element 15B and/or the third flexible fluid connection element 23 and/or the fourth fluid connection element 21A and/or the fifth flexible fluid connection element 21B, can be at least partially transparent or translucent to visualize the flow of the first powder and/or of the second powder and/or of the mixed powder therethrough.

### Powder

The mixed powder can be intended for additive manufacturing and/or manufacturing by sintering, at least one of the first powder and of the second powder being a recycled powder. For example, the first powder is a new powder and the second powder is a recycled powder and/or the first powder is a recycled powder and the second powder is a recycled powder. By “recycled powder”, it is meant for example a powder that has already been used, for example within the framework of an additive manufacturing method, for example metal additive manufacturing with selective laser melting. The recycled powder can differ from a new powder in that it has a different composition and/or load, and/or the presence of additional oxides, and/or splashes.

The first powder and the second powder can differ in their composition and/or their property (ies). The first powder and/or the second powder can be one or more homogeneous or heterogeneous powder(s). The first powder and/or the second powder can be one or more metal for example oxidizable powder(s). The first powder and/or the second powder can comprise nickel and/or titanium and/or aluminum and/or inconel (registered trademark) and/or copper and/or iron. The first powder and/or the second powder can be one or more nickel or aluminum or iron or titanium or copper based alloy powder(s). The first powder and/or the second powder can be one or more Inconel powder(s) (registered trademark), for example Inconel® 625 or Inconel® 718, or AlSi7Mg0.6, or TA6V, or 316L, or 42CrMo4 (also known under the reference AlSI4140), or Maraging 300 powder(s). Alternatively, the first powder and/or the second powder can be plastic or ceramic.

The first powder and/or the second powder can be one or more additive manufacturing powder(s). The invention particularly finds utility in the field of metal additive manufacturing, particularly with respect to or within the framework of a selective laser melting method (laser beam melting), for example selective laser melting called “powder bed”, in which significant quantities of powder are involved. Alternatively, the first powder and/or the second powder can be one or more powder(s) of manufacturing by sintering. The grain size distribution of the first powder and/or of the second powder can be of a size systematically less than 200 μm, and for example typically mostly distributed between 5 and 60 μm, for example for the selective laser melting method.

The first powder and/or the second powder can be reactive, for example capable of self-ignition, for example upon contact with an oxidant such as oxygen, for example gaseous oxygen, for example atmospheric oxygen. The first powder and/or the second powder can have a reactive nature and/or an ATEX risk. Indeed, the first powder and/or second powder particles can constitute “combustible dust” within the meaning of the definition 3.18.1 of the standard NF EN 60079-0 of January 2013 and are therefore likely to participate in the formation of an “explosive dust atmosphere” within the meaning of the definition 3.31 of the standard NF EN 60079-0 of January 2013, for example with air present in the first reservoir 2A and/or the second reservoir 2B and/or the third reservoir 2C and/or the first dosing apparatus 3A, and/or the second dosing apparatus 3B and/or the mixer 4, and/or the fluid connection means between the first reservoir 2A and the first dosing apparatus 3A, and/or the fluid connection means between the second reservoir 2B and the second dosing apparatus 3B, and/or the fluid connection means between the third reservoir 2C and the mixer 4, for example during their suspension by their mechanical agitation during dosing and/or mixing operations.

Furthermore, the first powder and/or the second powder can be one or more powder(s) with low minimum ignition energy (for example less than 100 mJ), or very low minimum ignition energy (for example less than 25 mJ). For example, tests carried out according to standard NF EN 13821 or BS EN 13821:2002: “Determination of the minimum ignition energy of dust/air mixtures” to determine the minimum energy of an electric spark capable of igniting a cloud of dust make it possible to find minimum ignition energies comprised between 50 and 60 mJ for some powders known under the reference AlSi7Mg, or less than 2 mJ for some TA6V powders. Alternatively or additionally, the first powder and/or the second powder may have been passivated, for example by the formation of a surface oxide layer, for example by exposure, for example voluntary or involuntary exposure, to an oxidant.

The first powder and/or the second powder can have limited flowability from the sorption of a small quantity of water, for example intolerable bonding phenomena for use in additive manufacturing, from sorption in water equivalent to 0.05% to 0.5% of the mass of the powder grains. The first powder and/or the second powder can have an apparent density comprised between 1 and 5.

The powder mixture can have an oxygen mass content averaged over the concerned volume of powder less than or equal to 0.13%. The powder mixture obtainable by means of the device can be of the Ti-6Al-4V type, for example grade 23 or ELI. Thus, for a batch of second recycled powder, having an oxygen content of 0.20%, it is necessary to mix it with a batch of new powder having an oxygen content of 0.11% in a ratio of new powder by the mass of recycled powder worth 89/11 to obtain a powder with an oxygen content of 0.12% (more specifically 0.1199%), thus allowing for example its use in additive manufacturing, for example as Ti-6Al-4V grade 23.

The first reservoir 2A and/or the second reservoir 2B and/or the third reservoir 2C and/or the first dosing apparatus 3A and/or the second dosing apparatus 3B and/or the mixer 4 can each comprise an inner surface adapted to be in contact with the powder. The inner surface can comprise or be made of stainless steel, for example of the type 304 L, for example with a surface finish of level 2B or better. The inner surface can be made of a material resistant to corrosion during cleaning with water. The finish level of the inner surface can be adapted to prevent or limit the trapping of powder grains in surface micro-asperities of the inner surface. Trapped grains could indeed withstand a cleaning and contaminate a batch of powder made subsequently.

### Support Structure

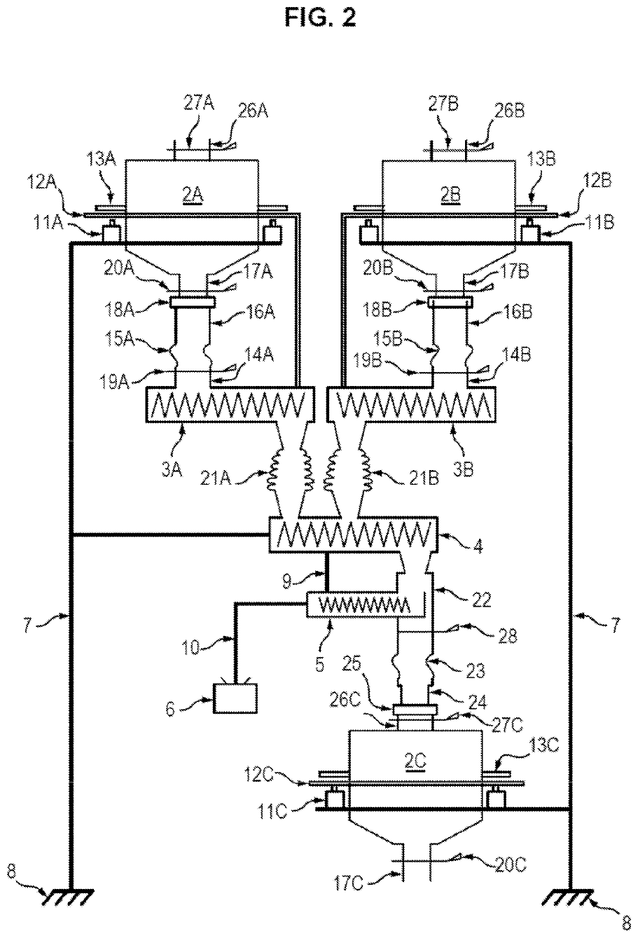

As illustrated in FIG. 2, the device can comprise a support structure 7, adapted to support the device. The support structure 7 can be in connection with the ground 8. The support structure 7 can be rigid. The support structure 7 can form a main structure of the device.

The support structure 7 can support the mixer 4 and/or the first reservoir 2A and/or the second reservoir 2B and/or the third reservoir 2C and/or an expansion sub-assembly 68 as described below and/or a distribution sub-assembly 69 as described below and/or a collection sub-assembly 81 as described below. The support structure 7 can comprise two gas plates or gas panels 138 and 139.

The sampler 5 can be connected by a mechanical connection 9, for example a rigid connection, with the mixer 4. The sampler 5 can be particularly fixed to the mixer 4. The sampler 5 can be forced to remain secured to the mixer 4. The sampler 5 is for example mounted cantilevered on the third upstream duct 22 which forms for example a welded extension of the mixer 4. The container 6, when connected to the sampler 5, can be thereby connected by a mechanical connection 10, for example a rigid connection, with the sampler 5. The container 6 can be particularly fixed, for example in a removable manner, to the sampler 5.

The device can comprise first means for weighing the first reservoir 2A and/or the first dosing apparatus 3A and/or fluid connection means between the first reservoir 2A and the first dosing apparatus 3A, including their content, for example the first contained powder. The first weighing means can comprise one or more first weighing cell(s) 11A, for example one or more first load cell(s), for example, a set of four load cells. The first weighing cell(s) 11A can be electronic. The first weighing cell(s) 11A can be supported by the support structure 7. The first weighing means can comprise a first cradle 12A for accommodating the first reservoir 2A. The first cradle 12A can rest on the first weighing cell(s) 11A. The first reservoir 2A can comprise one or more first lug(s) 13A, through which the first reservoir 2A rests on the first cradle 12A. The first cradle 12A can also be in rigid mechanical connection with the first dosing apparatus 3A, for example fixed to the first dosing apparatus 3A.

The device can comprise second means for weighing the second reservoir 2B and/or the second dosing apparatus 3B and/or fluid connection means between the second reservoir 2B and the second dosing apparatus 3B, including their content, for example the second contained powder. The second weighing means can comprise one or more second weighing cell(s) 11B, for example one or more second load cell(s), for example, a set of four load cells. The second weighing cell(s) 11B can be electronic. The second weighing cell(s) 11B can be supported by the support structure 7. The second weighing means can comprise a second cradle 12B for accommodating the second reservoir 2B. The second cradle 12B can rest on the second weighing cell(s) 11B. The second reservoir 2B can comprise one or more second lug(s) 13B, through which the second reservoir 2B rests on the second cradle 12B. The second cradle 12B can also be in rigid mechanical connection with the second dosing apparatus 3B, for example fixed to the second dosing apparatus 3B.

The device can comprise third means for weighing the third reservoir 20, including its content, for example the contained mixed powder. The third weighing means can comprise one or more third weighing cell(s) 11C, for example one or more third load cell(s), for example, a set of four load cells. The third weighing cell(s) 11C can be electronic. The third weighing cell(s) 11C can be supported by the support structure 7. The device can comprise a third cradle 12C for accommodating the third reservoir 2C. The third cradle 12C can rest on the third weighing cell(s) 11C. The third reservoir 2C can comprise one or more third lug(s), 13C through which the third reservoir 2C rests on the third cradle 12C. The first load cell(s) and/or the second load cell(s), and/or the third load cell(s) can be one or more weighing sensor(s) Scaime F60X with a capacity of 100 kg and an accuracy from 30 to 35 grams.

Gas Inlet and/or Outlet Means

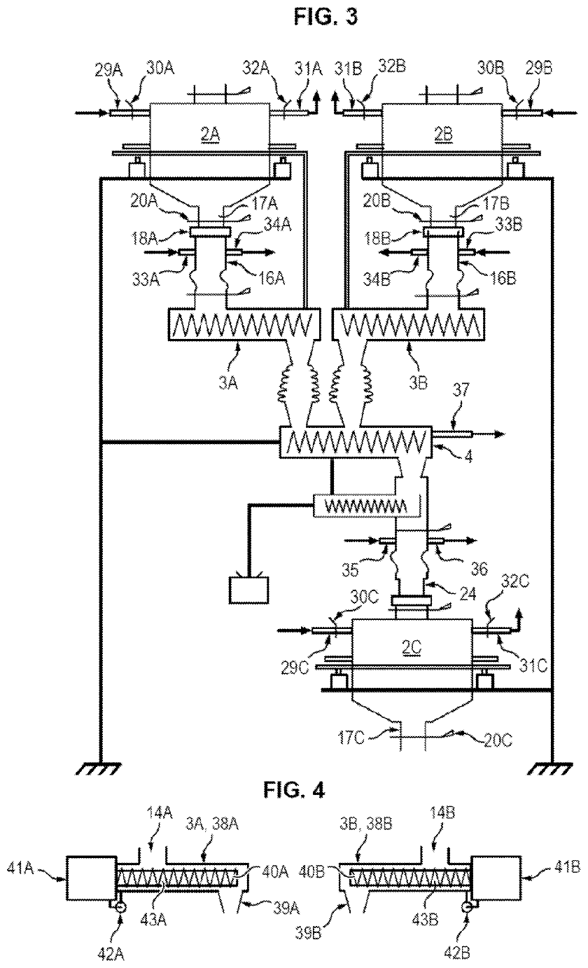

As illustrated in FIG. 3, the device can comprise gas inlet and/or outlet means. The first reservoir 2A and/or the second reservoir 2B and/or the third reservoir 2C and/or the fluid connection means between the first reservoir 2A and the first dosing apparatus 3A and/or the fluid connection means between the second reservoir 2B and the second dosing apparatus 3B and/or the mixer 4 and/or the fluid connection means between the mixer 4 and the third reservoir 2C, can comprise dedicated gas inlet and/or outlet means.

The first reservoir 2A can comprise a gas inlet tapping 29A of the first reservoir and/or a gas outlet tapping 31A of the first reservoir. Part of the first reservoir 2A, for example a cover, can be provided with the gas inlet tapping 29A of the first reservoir and/or with the gas outlet tapping 31A of the first reservoir. The gas inlet tapping 29A of the first reservoir can comprise a tapping valve 30A of the first reservoir, and/or the gas outlet tapping 31A of the first reservoir can comprise a tapping valve 32A of the first reservoir.

The fluid connection means between the first reservoir 2A and the first dosing apparatus 3A can comprise a gas inlet tapping 33A of the first connection means and/or a gas outlet tapping 34A of the first connection means. The first rigid part 16A can be provided with the gas inlet tapping 33A of the first connection means and/or with the gas outlet tapping 34A of the first connection means.

The second reservoir 2B can comprise a gas inlet tapping 29B of the second reservoir and/or a gas outlet tapping 31B of the second reservoir. Part of the second reservoir 2B, for example a cover, can be provided with the gas inlet tapping 29B of the second reservoir and/or the gas outlet tapping 31B of the second reservoir. The gas inlet tapping 29B of the second reservoir can comprise a tapping valve 30B of the second reservoir, and/or the gas outlet tapping 31B of the second reservoir can comprise a tapping valve 32B of the second reservoir.

The fluid connection means between the second reservoir 2B and the second dosing apparatus 3B can comprise a gas inlet tapping 33B of the second connection means and/or a gas outlet tapping 34B of the second connection means. The second rigid part 16B can be provided with the gas inlet tapping 33B of the second connection means and/or with the gas outlet tapping 34B of the second connection means. The third reservoir 2C can comprise a gas inlet tapping 29C of the third reservoir and/or a gas outlet tapping 31C of the third reservoir. Part of the third reservoir 2C, for example a cover, can be provided with the gas inlet tapping 29C of the third reservoir and/or with the gas outlet tapping 31C of the third reservoir. The gas inlet tapping 29C of the third reservoir can comprise a tapping valve 30C of the third reservoir, and/or the gas outlet tapping 31C of the third reservoir can comprise a tapping valve 32C of the third reservoir.

The fluid connection means between the mixer 4 and the third reservoir 2C can comprise a gas inlet tapping 35 of the third connection means and/or a gas outlet tapping 36 of the third connection means. The third upstream duct 22 can be provided with the gas inlet tapping 35 of the third connection means and/or with the gas outlet tapping 36 of the third connection means.

The mixer 4 can comprise an outlet tapping 37 of the mixer.

The gas inlet tapping 29A of the first reservoir and/or the gas outlet tapping 31A of the first reservoir and/or the gas inlet tapping 29B of the second reservoir and/or the gas outlet tapping 31B of the second reservoir and/or the gas inlet tapping 29C of the third reservoir and/or the gas outlet tapping 31C of the third reservoir and/or the gas inlet tapping 35 of the third connection means and/or the gas outlet tapping 36 of the third connection means and/or the outlet tapping 37 of the mixer can each comprise a quick coupler, for example self-sealing upon disconnection. By “quick coupler”, it is meant for example connectable by simple snap-fitting or the like.

The gas outlet tapping 31A of the first reservoir and/or the gas outlet tapping 31B of the second reservoir and/or the gas outlet tapping 31C of the third reservoir and/or the gas outlet tapping 36 of the third connection means and/or the outlet tapping 37 of the mixer can each comprise one or more filter(s) arranged to prevent entrainment of powder by the exiting gas, for example sintered filters, for example of approximately 7 μm filter porosity diameter.

### Inerting Means

### General Description of the Inerting Means

The device can comprise inerting means. The inerting means can be adapted to preserve the first powder and/or the second powder and/or the mixed powder from contamination by the external atmosphere, for example humidity or oxidation, for example by the distribution of an inerting gas. The inerting gas can be a dry gas devoid of oxygen and advantageously devoid of nitrogen and hydrogen, for example argon.

The inerting means can be adapted to prevent the appearance, within the device, of an explosive atmosphere resulting from the simultaneous presence of powder and oxygen particles, for example by the inerting gas distribution.

The inerting means can be adapted to prevent the release of powder carried by the inerting gas outside the device, for example upon disconnection of part of the device, for example by means of filters retaining the powder and located at the disconnection point, and of valves or shutters interrupting the circulation of gas at the disconnection point.

The inerting means can be adapted to distribute a gas, for example an inerting gas, at one or more distribution point(s) of the device. The inerting means can comprise distribution means adapted to distribute the gas to the distribution point(s) of the device.

The inerting means can be adapted to collect gas at one or more collection points of the device. The collected gas can comprise the inerting gas. The inerting means can thus comprise collection means adapted to collect the gas at the distribution point(s) of the device.

The inerting means can be adapted to, for example selectively or commonly, distribute the inerting gas to the, and collect the inerting gas from, the first reservoir 2A and/or second reservoir 2B and/or third reservoir 2C and/or first dosing apparatus 3A and/or second dosing apparatus 3B and/or mixer 4 and/or sampler 5, and/or powder and gas-tight fluid connection means between the first reservoir 2A and the first dosing apparatus 3A and/or powder and gas-tight fluid connection means between the second reservoir 2B and the second dosing apparatus 3B and/or powder and gas-tight fluid connection means between the first dosing apparatus 3A and the mixer 4 and/or powder and gas-tight fluid connection means between the second dosing apparatus 3B and the mixer 4, and/or powder and gas-tight fluid connection means between the mixer 4 and the third reservoir 2C.

The distribution of the inerting gas to the first dosing apparatus 3A and/or to the second dosing apparatus 3B and/or to the mixer 4 and/or to the sampler 5, as well as the collection of the inerting gas from the first dosing apparatus 3A and/or or from the second dosing apparatus 3B and/or from the mixer 4 and/or from the sampler 5, can be obtained by distribution of the inerting gas to the first dosing apparatus 3A and/or to the second dosing apparatus 3B and/or to the mixer 4 and/or to the sampler 5 through the associated fluid connection means, as well as by collection of the inerting gas through the associated fluid connection means.

The distribution and/or collection can be carried out commonly or separately, and/or sequentially or simultaneously. By “common”, it is meant that several or all of the elements of the device capable of distributing or collecting the inerting gas are maintained in fluid communication, so that the distribution and/or collection at the level of one of the elements maintained in fluid communication also causes the distribution and/or the collection of the other element(s) maintained in fluid communication. By “separate”, it is meant that several or all of the elements of the device capable of distributing or collecting the inerting gas are fluidly isolated from each other, so that the distribution and/or collection at the level of one of the elements does not cause the distribution and/or collection of the other fluidly isolated element(s). By “simultaneous”, it is meant that the distribution and/or collection of several or all of the elements of the device capable of distributing or collecting the inerting gas is carried out at the same time, whether because the elements are in fluid communication or because the distribution and/or collection is carried out at the same time in parallel between the fluidly isolated elements. By “sequential”, it is meant that the distribution and/or collection of several or all of the elements of the device capable of distributing or collecting the inerting gas is carried out one after the other between the fluidly isolated elements. For example, the distribution and/or collection of gas in the powder and gas-tight fluid connection means between the first reservoir 2A and the first dosing apparatus 3A can be carried out separately but simultaneously relative to the distribution and/or collection of gas in the powder and gas-tight fluid connection means between the second reservoir 2B and the second dosing apparatus 3B, and separately from the rest of the device. Again, for example, the distribution and/or collection of gas in the first reservoir 2A can be carried out separately and before the distribution and/or collection of gas in the powder and gas-tight fluid connection means between the first reservoir 2A and the first dosing apparatus 3A. For example again, the distribution and/or collection of gas can be carried out commonly and simultaneously throughout the device.

The inerting can be a continuous sweeping, so that the injected inerting gas is constantly renewed. The sweeping further makes it possible to complete drying of the device after its cleaning.

### Distribution Means

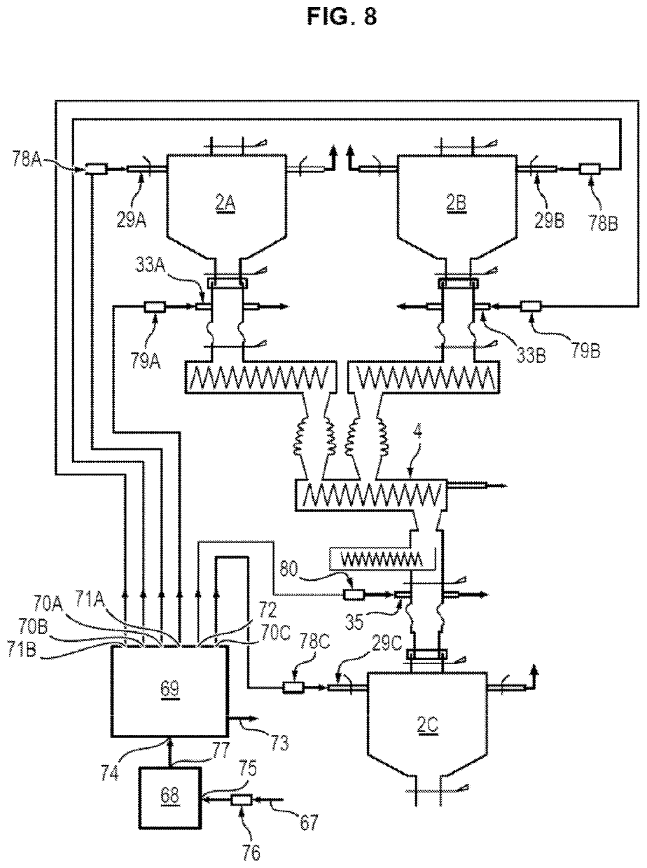

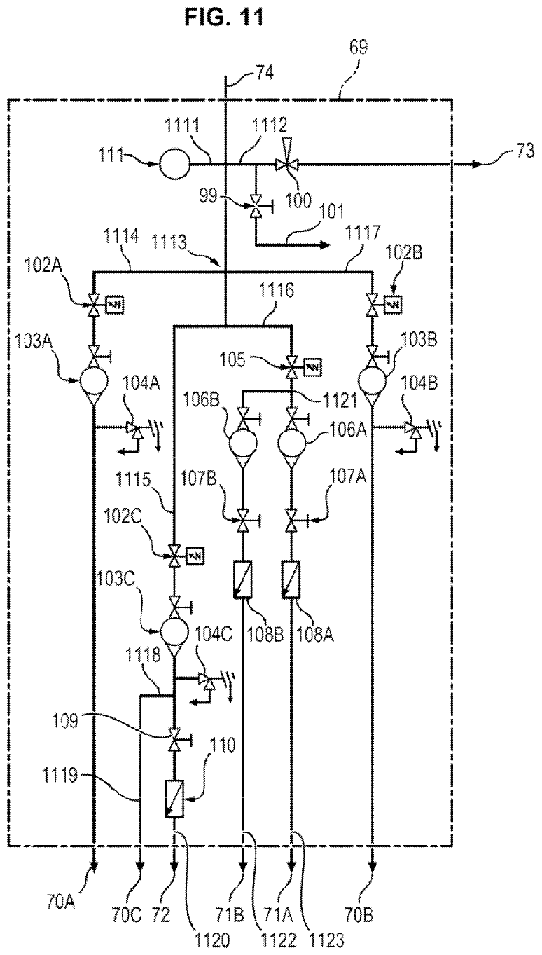

As illustrated in FIGS. 8 and 11, the distribution means can comprise a distribution assembly. The distribution means can comprise an expansion sub-assembly 68 and a distribution sub-assembly 69. The distribution means can be adapted to supply the device with inerting gas from an external supply network 67. The pressure in the external supply network 67 can be greater than or equal to 6 bars, for example less than or equal to 10 bars, for example substantially equal to 8 bars.

### Distribution Sub-Assemblies

### Inlet and Outlet(s) of the Distribution Sub-Assembly

The distribution sub-assembly 69 can comprise one or more gas outlet(s) 70A, and/or 70B, and/or 70C, and/or 71A, and/or 71B, and/or 72, and/or 73 of the distribution sub-assembly 69, and/or a gas inlet 74 of the distribution sub-assembly 69.

The distribution sub-assembly 69 can be connected to the collection sub-assembly 81, for example by means of the outlet 73 of the distribution sub-assembly 69.

The distribution sub-assembly 69 can be connected to the first reservoir 2A. The outlet 70A of the distribution sub-assembly 69 can thus be connected to the gas inlet tapping 29A of the first reservoir. The distribution means can comprise a connector 78A arranged to allow the connection of the outlet 70A to the gas inlet tapping 29A of the first reservoir.

The distribution sub-assembly 69 can be connected to the second reservoir 2B. The outlet 70B of the distribution sub-assembly 69 can thus be connected to the gas inlet tapping 29B of the second reservoir. The distribution means can comprise a connector 78B arranged to allow the connection of the outlet 70B to the gas inlet tapping 29B of the second reservoir.

The distribution sub-assembly 69 can be connected to the third reservoir 2C. The outlet 70C of the distribution sub-assembly 69 can thus be connected to the gas inlet tapping 29C of the third reservoir.

The distribution means can comprise a connector 78C arranged to allow the connection of the outlet 70C to the gas inlet tapping 29C of the third reservoir.

The distribution sub-assembly 69 can be connected to the fluid connection means between the first reservoir 2A and the first dosing apparatus 3A. The outlet 71A of the distribution sub-assembly 69 can thus be connected to the gas inlet tapping 33A of the first connection means. The distribution means can comprise a connector 79A arranged to allow the connection of the outlet 71A to the gas inlet tapping 33A of the first connection means.

The distribution sub-assembly 69 can be connected to the fluid connection means between the second reservoir 2B and the second dosing apparatus 3B. The outlet 71B of the distribution sub-assembly 69 can thus be connected to the gas inlet tapping 33B of the second connection means. The distribution means can comprise a connector 79B arranged to allow the connection of the outlet 71B to the gas inlet tapping 33B of the second connection means.

The distribution sub-assembly 69 can be connected to the fluid connection means between the mixer 4 and the third reservoir 2C. The outlet 72 of the distribution sub-assembly 69 can thus be connected to the gas inlet tapping 35 of the third connection means. The distribution means can comprise a connector 80 arranged to allow the connection of the outlet 72 to the gas inlet tapping 35 of the third connection means.

### Internal Structure of the Distribution Sub-Assembly

Between the gas inlet 74 and the gas outlet 73 of the distribution sub-assembly 69, the distribution sub-assembly 69 can comprise a first branch 1111 into a path 1112 leading to the gas outlet 73 and into a path leading to the gas outlet(s) 70A and/or 70B and/or 70C and/or 71A and/or 71B and/or 72. Between the gas inlet 74 and the gas outlet 73 of the distribution sub-assembly 69, for example along the path 1112 leading to the gas outlet 73, the distribution sub-assembly 69 can comprise a valve 100, for example a manual valve. Between the gas inlet 74 and the gas outlet 73 of the distribution sub-assembly 69, for example upstream of the valve 100, the distribution sub-assembly 69 can comprise a branch, for example a tapping, for connection to a venting point 101, a valve 99 which can be provided between the connection tapping to a venting point 101 and said venting point 101. The valve 99 can be manual.

By “upstream”, respectively “downstream”, it is meant here upstream, respectively downstream, depending on the direction of flow of the gas between the gas inlet 74 and a gas outlet of the distribution sub-assembly 69. Likewise, by “between”, it is meant between depending on the direction of flow of the gas between the gas inlet 74 and a gas outlet of the distribution sub-assembly 69.

Between the gas inlet 74 and the gas outlets 70A and/or 70B and/or 70C and/or 71A and/or 71B and/or 72 of the distribution sub-assembly 69, for example downstream of the first branch 1111, the distribution sub-assembly 69 can comprise a second branch 1113 into a path 1114 leading to the gas outlet 70A and/or into a path 1117 leading to the outlet 70B and/or into a path 1115 leading to the gas outlets 70C and 72, and/or into a path 1116 leading to the gas outlets 71B and 71A.

Between the gas inlet 74 and the gas outlet 70A of the distribution sub-assembly 69, for example along the path 1114 leading to the gas outlet 70A, the distribution sub-assembly 69 can comprise a valve 102A and/or a flow rate adjustment and monitoring system 103A and/or a pressure relief monitoring system comprising a tapping connected to a pressure relief valve 104A. The valve 102A can for example be a solenoid valve, adapted to close in the event of a power supply failure, for example driven by data processing means 65 as described below. The flow rate adjustment and monitoring system 103A can be an adjustable ball rotameter. The pressure relief valve 104A can be calibrated to 300 mbar. The valve 102A can be disposed downstream of the second branch 1113. The flow rate adjustment and monitoring system 103A can be disposed downstream of the second branch 1113 and/or of the valve 102A. The pressure relief monitoring system comprising a tapping connected to a pressure relief valve 104A can be disposed downstream of the second branch 1113 and/or of the valve 102A and/or of the flow rate adjustment and monitoring system 103A.

Between the gas inlet 74 and the gas outlet 70B of the distribution sub-assembly 69, for example along the path 1117 leading to the gas outlet 70B, the distribution sub-assembly 69 can comprise a valve 102B and/or or a flow rate adjustment and monitoring system 103B and/or a pressure relief monitoring system comprising a tapping connected to a pressure relief valve 104B. The valve 102B can for example be a solenoid valve, adapted to close in the event of a power supply failure, for example driven by data processing means 65 as described below. The flow rate adjustment and monitoring system 103B can be an adjustable ball rotameter. The pressure relief valve 104B can be calibrated to 300 mbar. The valve 102B can be disposed downstream of the second branch 1113. The flow rate adjustment and monitoring system 103B can be disposed downstream of the second branch 1113 and/or of the valve 102B. The pressure relief monitoring system comprising a tapping connected to a pressure relief valve 104B can be disposed downstream of the second branch 1113 and/or of the valve 102B and/or of the flow rate adjustment and monitoring system 103B.

Between the gas inlet 74 and the gas outlet 70C and/or the gas outlet 72 of the distribution sub-assembly 69, for example along the path 1115 leading to the gas outlet 70C and to the gas outlet 72, the distribution sub-assembly 69 can comprise a valve 102C and/or a flow rate adjustment and monitoring system 103C and/or a pressure relief monitoring system comprising a tapping connected to a pressure relief valve 104C. The valve 102C can for example be a solenoid valve, adapted to close in the event of a power supply failure, for example driven by data processing means 65 as described below. The flow rate adjustment and monitoring system 103C can be an adjustable ball rotameter. The pressure relief valve 104C can be calibrated to 300 mbar. The valve 102C can be disposed downstream of the second branch 1113. The flow rate adjustment and monitoring system 103C can be disposed downstream of the second branch 1113 and/or of the valve 102C. The pressure relief monitoring system comprising a tapping connected to a pressure relief valve 104C can be disposed downstream of the second branch 1113 and/or of the valve 102C and/or of the flow rate adjustment and monitoring system 103C.

Between the gas inlet 74 and the gas outlet 70C and/or the gas outlet 72 of the distribution sub-assembly 69, for example along the path 1115 leading to the gas outlet 70C and to the gas outlet 72, the distribution sub-assembly 69 can comprise a third branch 1118 into a path 1119 leading to the gas outlet 70C and into a path 1120 leading to the gas outlet 72. The third branch 1118 can be disposed downstream of the valve 102C and/or of the flow rate adjustment and monitoring system 103C and/or of the pressure relief monitoring system comprising a tapping connected to a pressure relief valve 104C. Between the gas inlet 74 and the gas outlet 72 of the distribution sub-assembly 69, for example along the path 1115 leading to the gas outlet 70C and to the gas outlet 72, for example along the path 1120 leading to the gas outlet 72, the distribution sub-assembly 69 can comprise a valve 109 and/or a check valve 110. The valve 109 can be manual. The valve 109 can be disposed downstream of the third branch 1118 and/or of the valve 102C and/or of the flow rate adjustment and monitoring system 103C and/or of the pressure relief monitoring system comprising a tapping connected to a pressure relief valve 104C. Between the gas inlet 74 and the gas outlet 71A and/or the gas outlet 71B of the distribution sub-assembly 69, for example along the path 1116 leading to the gas outlet 71A and the gas outlet 71B, the distribution sub-assembly 69 can comprise a valve 105. The valve 105 can be for example a solenoid valve, for example adapted to close in the event of a power supply failure, for example driven by data processing means 65 as described below.

Between the gas inlet 74 and the gas outlet 71A and/or the gas outlet 71B of the distribution sub-assembly 69, for example along the path 1116 leading to the gas outlet 71A and to the gas outlet 71B, the distribution sub-assembly 69 can comprise a fourth branch 1121 into a path 1122 leading to the gas outlet 71B and into a path 1123 leading to the gas outlet 71A.

Between the gas inlet 74 and the gas outlet 71B of the distribution sub-assembly 69, for example along the path 1116 leading to the gas outlet 71A and to the gas outlet 71B, for example along the path 1122 leading to the gas outlet 71B, the distribution sub-assembly 69 can comprise a flow rate adjustment and monitoring system 106B and/or a valve 107B and/or a check valve 108B. The flow rate adjustment and monitoring system 106B can be an adjustable ball rotameter. The valve 107B can be manual. The flow rate adjustment and monitoring system 106B can be disposed downstream of the valve 105 and/or of the fourth branch 1121. The valve 107B can be disposed downstream of the valve 105 and/or of the fourth branch 1121 and/or of the flow rate adjustment and monitoring system 106B. The check valve 108B can be disposed downstream of the valve 105 and/or of the fourth branch 1121 and/or of the flow rate adjustment and monitoring system 106B and/or of the valve 106B.

Between the gas inlet 74 and the gas outlet 71A of the distribution sub-assembly 69, for example along the path 1116 leading to the gas outlet 71A and to the gas outlet 71B, for example along the path 1123 leading to the gas outlet 71A, the distribution sub-assembly 69 can comprise a flow rate adjustment and monitoring system 106A and/or a valve 107A and/or a check valve 108A. The flow rate adjustment and monitoring system 106A can be an adjustable ball rotameter. The valve 107A can be manual. The flow rate adjustment and monitoring system 106A can be disposed downstream of the valve 105 and/or of the fourth branch 1121. The valve 107A can be disposed downstream of the valve 105 and/or of the fourth branch 1121 and/or of the flow rate adjustment and monitoring system 106A. The check valve 108A can be disposed downstream of the valve 105 and/or of the fourth branch 1121 and/or of the flow rate adjustment and monitoring system 106A and/or of the valve 106A.

The distribution sub-assembly 69 also includes a pressure sensor-transmitter 111 configured to measure the pressure at the gas inlet 74, the pressure at the gas inlet 74 being for example comprised between 1 and 1.5 bars. Unless otherwise stated, the pressures indicated are relative pressures, for example compared to atmospheric pressure. The pressure sensor-transmitter 111 can be configured to communicate with data processing means 65 as described below, for example so as to transmit a measured pressure to the data processing means 65. The pressure sensor-transmitter 111 can be configured to measure a pressure ranging from 0 to 4 bars. The pressure sensor-transmitter 111 can be of the Wika type S20.

### Expansion Sub-Assembly

The expansion sub-assembly 68 can comprise a gas inlet 75 of the expansion sub-assembly 68. The gas inlet 75 of the expansion sub-assembly 68 can be connected to the external supply network 67. The distribution means can comprise a quick coupler 76, arranged to connect the gas inlet 75 of the expansion sub-assembly 68 to the external supply network 67. The expansion sub-assembly 68 can comprise a gas outlet 77 of the expansion sub-assembly 68. The gas outlet 77 of the expansion sub-assembly 68 can be connected to the gas inlet 74 of the distribution sub-system 69.

FIG. 10 more specifically describes the expansion sub-assembly 68. The expansion sub-assembly 68 can comprise a valve 95 and/or a check valve 96 and/or a pressure sensor-transmitter 97 and/or and a pressure regulator 98. The valve 95 can be a manual valve. The pressure sensor-transmitter 97 can be configured to communicate with data processing means 65 as described below, for example so as to transmit a measured pressure to the data processing means 65. The pressure regulator 98 can be configured so that, downstream of the pressure regulator 98, the pressure is set to a value comprised between 0.5 and 2.5 bars. The pressure sensor 98 can be adapted to measure pressures ranging from 0 to 10 bars. The pressure sensor 98 can be a Wika type sensor S20. The valve 95 can be downstream of the gas inlet 75 of the expansion sub-assembly 68 and upstream of the gas outlet 77. The check valve 96 can be downstream of the valve 95 and upstream of the gas outlet 77. The pressure sensor-transmitter 97 can be downstream of the valve 95 and/or of the check valve 96, and upstream of the gas outlet 77. The pressure regulator 98 can be downstream of the valve 95 and/or of the check valve 96 and/or of the pressure sensor-transmitter 97, and upstream of the gas outlet 77. By “upstream”, respectively “downstream”, it is meant here upstream, respectively downstream, depending on the direction of flow of the gas between the gas inlet 75 and the gas outlet 77 of the expansion sub-assembly 68. Likewise, by “between”, it is meant between depending on the direction of flow of the gas between the gas inlet 75 and the gas outlet 77 of the expansion sub-assembly 68.

The expansion sub-assembly 68 allows a connection to a network or to an inert gas reservoir which is at a pressure greater than the pressure which the device can withstand. The valve 95 can act as a switch from a gas point of view, by monitoring the entire intake. The check valve 96 can guarantee to avoid polluting the network by discharge of gas in the opposite direction.

### Collection Means

The collection means can comprise a collection assembly. The collection means can comprise a collection sub-assembly 81 and a vent 92.

The collection means can be adapted to collect gas, comprising for example the inerting gas, for example in order to release it. The collected gas can be a gas loaded with powder. The collected gas can be released into the atmosphere external to the device, for example in a secure manner. Indeed, it is thus possible to retain any powder particles present in the gas. Alternatively or additionally, it is possible to release any powder particles at a predetermined point and/or at a height/distance from areas to be preserved, for example from areas authorized for the movement of people sufficient for a possible release of powder to be dispersed until reaching a concentration safe for health before reaching people, and/or at a height/distance from the points of energy input with sufficient ignition for a possible release of powder to be dispersed until reaching a concentration that no longer presents an explosive risk.

### Collection Sub-Assembly

### Inlet(s) and Outlet of the Collection Sub-Assembly

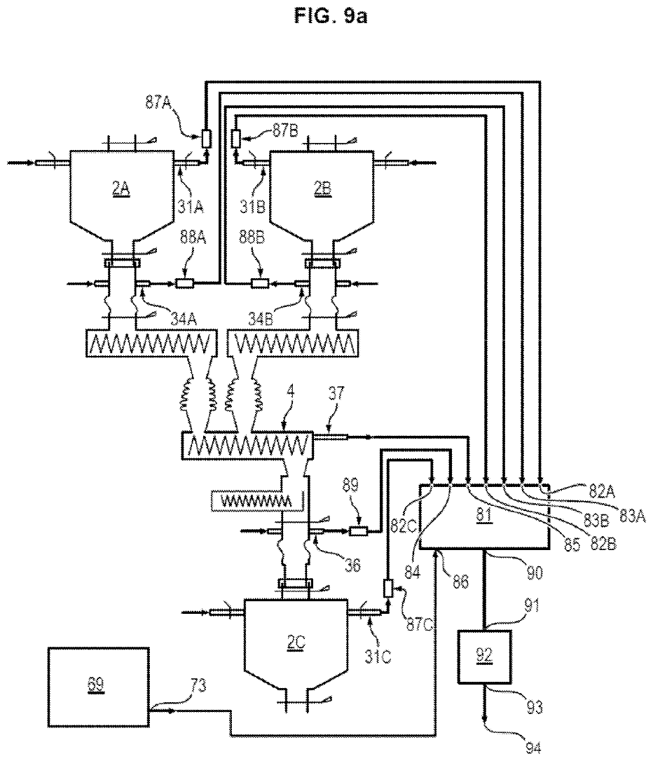

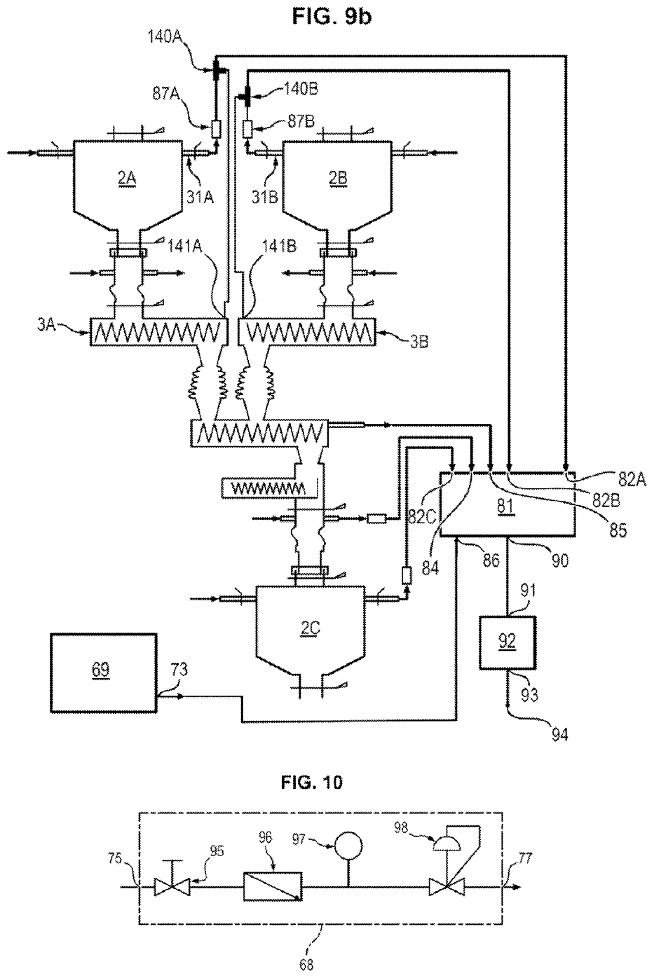

As illustrated in FIG. 9a, the collection sub-assembly 81 can comprise one or more gas inlet(s) 82A, and/or 82B, and/or 82C, and/or 83A, and/or 83B, and/or 84, and/or 85 and/or 86 of the collection sub-assembly 81 and/or a gas outlet 90 of the collection sub-assembly 81. The collection sub-assembly 81 can be connected to the first reservoir 2A. The inlet 82A of the collection sub-assembly 81 can thus be connected to the gas outlet tapping 31A of the first reservoir. The collection means can comprise a connector 87A arranged to allow the connection of the inlet 82A to the gas outlet tapping 31A of the first reservoir. The collection sub-assembly 81 can be connected to the second reservoir 2B. The inlet 82B of the collection sub-assembly 81 can thus be connected to the gas outlet tapping 31B of the second reservoir. The collection means can comprise a connector 87B arranged to allow the connection of the inlet 82B to the gas outlet tapping 31B of the second reservoir. The collection sub-assembly 81 can be connected to the third reservoir 2C. The inlet 82C of the collection sub-assembly 81 can thus be connected to the gas outlet tapping 31C of the third reservoir. The collection means can comprise a connector 87C arranged to allow the connection of the inlet 82C to the gas outlet tapping 31C of the third reservoir.

The collection sub-assembly 81 can be connected to the fluid connection means between the first reservoir 2A and the first dosing apparatus 3A. The inlet 83A of the collection sub-assembly 81 can thus be connected to the gas outlet tapping 34A of the first connection means. The collection means can comprise a connector 88A arranged to allow the connection of the inlet 83A to the gas outlet tapping 34A of the first connection means.

The collection sub-assembly 81 can be connected to the fluid connection means between the second reservoir 2B and the second dosing apparatus 3B. The inlet 83B of the collection sub-assembly 81 can thus be connected to the gas outlet tapping 34B of the second connection means. The collection means can comprise a connector 88B arranged to allow the connection of the inlet 83B to the gas outlet tapping 34B of the second connection means.

The collection sub-assembly 81 can be connected to the fluid connection means between the mixer 4 and the third reservoir 2C. The inlet 84 of the collection sub-assembly 81 can thus be connected to the gas outlet tapping 36 of the third connection means. The collection means can comprise a connector 89 arranged to allow the connection of the inlet 84 to the gas outlet tapping 36 of the third connection means.

The collection sub-assembly 81 can be connected to the mixer 4. The inlet 85 of the collection sub-assembly 81 can thus be connected to the gas outlet tapping 37 of the mixer.

The collection sub-assembly 81 can be connected to the distribution sub-assembly 69. The inlet 86 of the collection sub-assembly 81 can thus be connected to the outlet 73 of the distribution sub-assembly 69.

The collection sub-assembly 81 can be connected to the vent 92. The outlet 90 of the collection sub-assembly 81 can thus be connected to a gas inlet 91 of the vent 92.

Another configuration, illustrated in FIG. 9b, varies in that the gas duct connecting a connector 87A as described below, connecting to the gas outlet tapping 31A of the first reservoir 2A, to the gas inlet 82A of the collection sub-assembly 81, can comprise a first triple branch 140A. The dosing apparatus 3A can comprise, at the end of the dosing screw on the dosing apparatus side, a gas tapping 141A. The coupler 87A, the tapping 141A and the gas inlet 82A of the collection sub-assembly 81 can be fluidly connected to the first triple branch 140A. Likewise, for example additionally, the other configuration, illustrated in FIG. 9b, can vary in that the gas duct connecting the coupler 87B (connecting to the gas outlet tapping 31B of the second reservoir 2B) to the gas inlet 82B of the collection sub-assembly 81, can comprise a second triple branch 140B. The dosing apparatus 3B can comprise, at the end of the dosing screw on the dosing apparatus side, a gas tapping 141B. The coupler 87B, the tapping 141B and the gas inlet 82B of the collection sub-assembly 81 can be fluidly connected to the second triple branch 140B. These configurations, which can exist independently or simultaneously, make it possible to improve the regularity of the flow of the powder through the dosing apparatus 3A, 3B, and therefore the compliance with the mixing setpoint, by balancing the inerting gas pressures in upstream and downstream of the dosing apparatus 3A, 3B.

### Internal Structure of the Collection Sub-Assembly

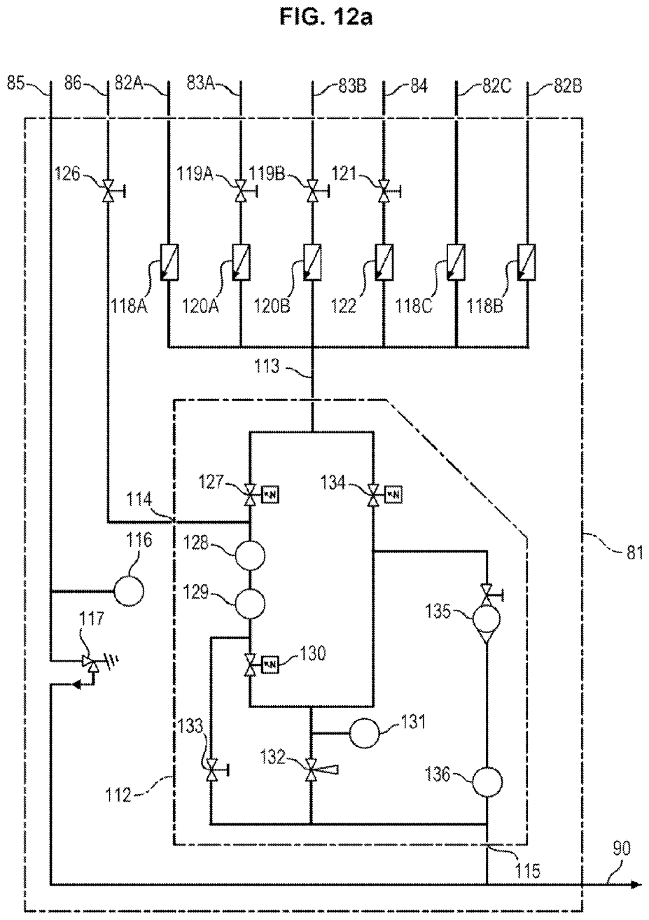

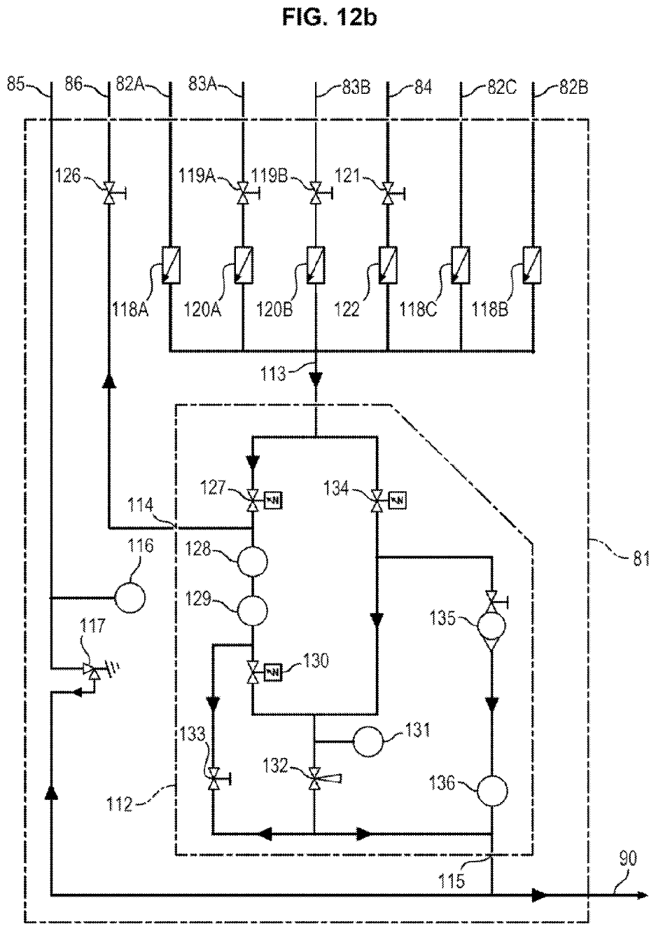

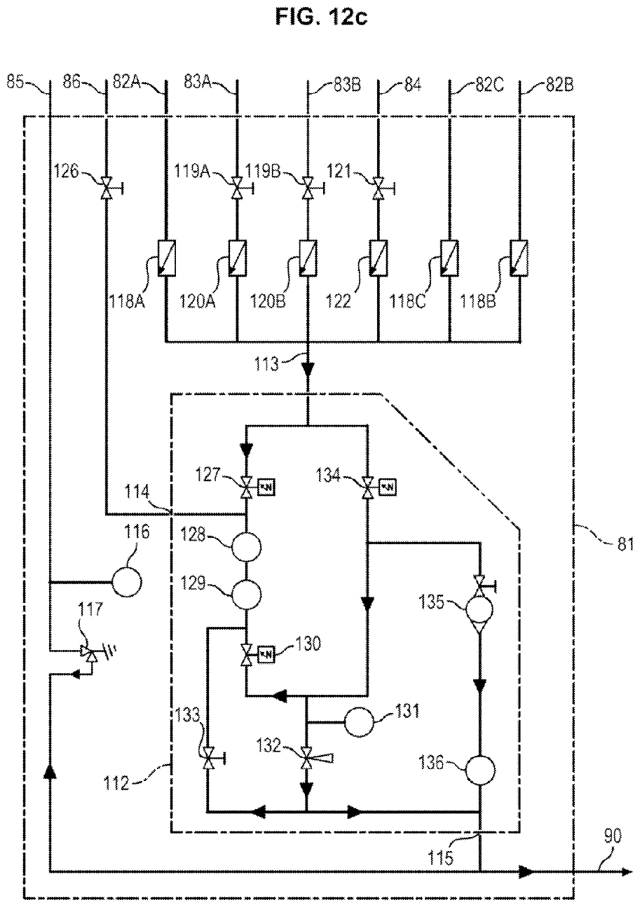

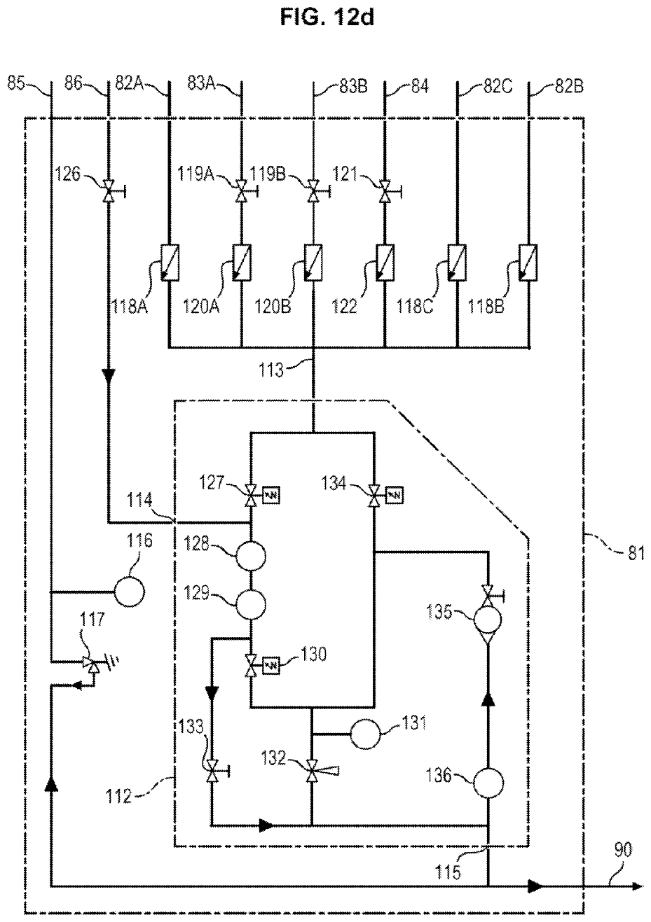

As illustrated in FIG. 12a, the collection sub-assembly 81 can comprise an analysis sub-assembly 112. The analysis sub-assembly 112 can be configured to measure and transmit properties of collected gas, the properties for example making it possible to estimate preservation of the powders and/or an explosive risk related to the possible presence of powder particles suspended in the collected gases. The measured and transmitted properties comprising the oxygen level in the gas and/or the humidity level in the gas, for example at a point located downstream of all of the outlet tappings 31A, 31B, 31C, 34A, 34B, and 36. The analysis sub-assembly 112 can comprise a first gas inlet 113 of an analysis sub-assembly 112 and/or a second gas inlet 114 of an analysis sub-assembly 112 and/or a gas outlet 115 of an analysis sub-assembly 112.

Between the gas inlet 85 and the gas outlet 90, the collection sub-assembly 81 can comprise a tapping connected to a pressure sensor-transmitter 116 and/or a pressure relief valve 117. The pressure sensor-transmitter 116 can be configured to communicate with data processing means 65 as described below, for example so as to transmit a measured pressure to the data processing means 65. The pressure sensor-transmitter 116 can be configured to measure a pressure ranging from 0 to 600 mbar. The collection sub-assembly 81 can be such that at the level of the pressure sensor-transmitter 116, the pressure can be of the order of 200 mbar. The pressure sensor-transmitter 116 can be of the Wika S20 type. The pressure relief valve 117 can comprise a venting outlet connected to the gas outlet 90. The gas outlet 90 being connected to the vent 92, even in the event of opening of the pressure relief valve 117, the gas potentially loaded with powder is well directed towards the vent 92, which can form for example a single, for example a secure, point of release of the gases to the atmosphere 94. The pressure relief valve 117 can be disposed downstream of the tapping connected to the pressure sensor-transmitter 116.

By “upstream”, respectively “downstream”, it is meant here upstream, respectively downstream, depending on the direction of flow of the gas between a gas inlet and a gas outlet of the collection sub-assembly 81. Likewise, by “between”, it is meant between depending on the direction of flow of the gas between a gas inlet and a gas outlet of the collection sub-assembly 81.

Between the gas inlet 82A of the collection sub-assembly 81, and the first gas inlet 113 of the analysis sub-assembly 112, the collection sub-assembly 81 can comprise a check valve 118A.

Between the inlet 82B of the collection sub-assembly 81, and the first gas inlet 113 of the analysis sub-assembly 112, the collection sub-assembly 81 can comprise a check valve 118B.

Between the inlet 82C of the collection sub-assembly 81, and the first gas inlet 113 of the analysis sub-assembly 112, the collection sub-assembly 81 can comprise a check valve 118C.

Between the inlet 83A of the collection sub-assembly 81, and the first gas inlet 113 of the analysis sub-assembly 112, the collection sub-assembly 81 can comprise a valve 119A and/or a check valve 120A. The valve 119A can be a manual valve. The check valve 120A can be downstream of the valve 119A.

Between the inlet 83B of the collection sub-assembly 81, and the first gas inlet 113 of the analysis sub-assembly 112, the collection sub-assembly 81 can comprise a valve 119B and/or a check valve 120B. The valve 119B can be a manual valve. The check valve 120B can be downstream of the valve 119B. Between the inlet 84 of the collection sub-assembly 81, and the first gas inlet 113 of the analysis sub-assembly 112, the collection sub-assembly 81 can comprise a valve 121 and/or a check valve 122. The valve 121 can be a manual valve. The check valve 122 can be downstream of the valve 121.

Between the gas inlet 86 of the collection sub-assembly 81, and the second gas inlet 114 of the analysis sub-assembly 112, the collection sub-assembly 81 can comprise a valve 126. The valve 126 can be manual.

The analysis sub-assembly 112 can comprise several gas circuits between the first gas inlet 113 of the analysis sub-assembly 112, the second gas inlet 114 of the analysis sub-assembly 112 and the gas outlet 115 of the analysis sub-assembly 112, for example a first and/or a second and/or a third and/or a fourth and/or a fifth circuit.

The first circuit can comprise, between the first gas inlet 113 of the analysis sub-assembly 112 and the gas outlet 115 of the analysis sub-assembly 112, a valve 127 and/or a relative humidity probe 128 and/or a first probe measuring the oxygen content 129 of the circulating gas and/or a valve 130 and/or a pressure sensor 131, for example a pressure gauge and/or a valve 132. The valve 127 can be a solenoid valve closing in the event of power supply failure. The valve 127 can be driven by data processing means 65 as described below. The relative humidity probe 128 can be in communication with data processing means 65 as described below, for example to transmit the relative humidity measurement.

The first probe measuring the oxygen content 129 of the circulating gas can be in communication with data processing means 65 as described below, for example to transmit the measurement of the oxygen content. The valve 130 can be a solenoid valve closing in the event of a power supply failure. The valve 130 can be driven by data processing means 65 as described below. The valve 132 can be manual. The valve 132 can be a discharger. The relative humidity probe 128 can be downstream of the valve 127. The first probe measuring the oxygen content 129 of the circulating gas can be downstream of the valve 127 and/or of the relative humidity probe 128. The valve 130 can be downstream of the valve 127 and/or of the relative humidity probe 128 and/or of the first probe measuring the oxygen content 129 of the circulating gas. The pressure sensor 131 can be downstream of the valve 127 and/or of the relative humidity probe 128 and/or of the first probe measuring the oxygen content 129 and/or of the valve 130. The valve 132 can be downstream of the valve 127 and/or of the relative humidity probe 128 and/or of the first probe measuring the oxygen content 129 and/or of the valve 130 and/or of the pressure sensor 131.

The second circuit can start along the first circuit, for example between the first probe measuring the oxygen content 129 and the valve 130. The second circuit can comprise a valve 133. The valve 133 can be manual. The second circuit can connect the first circuit and the gas outlet 115. The valve 133 can be disposed between the start of the second circuit and the outlet 115.

The third circuit can connect the first gas inlet 113 of the analysis sub-assembly 112 and the gas outlet 115 of the analysis sub-assembly 112. The third circuit can comprise a valve 134 and/or a flow rate adjustment and monitoring system 135 and/or a second probe measuring the oxygen content 136 of the circulating gas. The valve 134 can be a solenoid valve closing in the event of a power supply failure. The valve 134 can be driven by data processing means 65 as described below. The flow rate adjustment and monitoring system 135 can be an adjustable ball rotameter. The second probe measuring the oxygen content 136 of the circulating gas can be in communication with data processing means 65 as described below, for example to transmit the measurement of the oxygen content. The flow rate adjustment and monitoring system 135 can be downstream of the valve 134. The second probe measuring the oxygen content 136 of the circulating gas can be downstream of the valve 134 and/or of the flow rate adjustment and monitoring system 135.

The fourth circuit can start along the third circuit, for example between the valve 134 of the third circuit and the flow rate adjustment and monitoring system 135 of the third circuit. The fourth circuit can end up along the first circuit, for example between the valve 130 of the first circuit and the pressure sensor 131 of the first circuit.

The combination of the fourth circuit and of the flow rate adjustment and monitoring system 135 makes it possible to distribute a monitored fraction of the gas stream passing through the valve 134 towards the analyzer 136, and the remaining fraction towards the sensor 131 and the valve 32A, 32B. Indeed the gas stream passing through the valve 134, which is particularly equal to the gas stream collected at the inlet 113 by the rake bringing together the inlets 82A and/or 82B and/or 82C and/or 83A and/or 83B and/or 84 when the valve 127 is closed, can exceed the maximum gas stream value allowing the safe and accurate operation of the analyzer 136.

Additionally, the overall adjustment of the pressure levels prevailing in the mixer 4 and/or the dosing apparatuses 3A and/or 3B and/or the reservoirs 2A and/or 2B and/or 2C, requires providing an adjustable resistance to the entire stream collected at the inlet 113, and therefore particularly to the fraction of the stream passing through the valve 134 which is not distributed to the analyzer 136. The fourth circuit thus allows placing and using, upstream of the analyzer 136, the flow rate monitoring system 135 which allows adjusting the gas flow rate received by the analyzer 136 so as to allow the analyzer 136 to operate with safety and accuracy, and placing and using the adjustable valve or the discharger 132 which is adapted to globally adjust the pressure levels in the mixer 4 and/or the dosing apparatuses 3A and/or 3B and/or the reservoirs 2A and/or 2B and/or 2C by providing resistance to the gas stream passing therethrough. The fifth circuit can connect the second inlet 114 of the analysis sub-assembly to the first circuit. The fifth circuit can thus end up between the valve 127 of the first circuit and the relative humidity probe 128 of the first circuit. The outlet 115 of the analysis sub-assembly 112 can be connected to the outlet 90 of the collection sub-assembly 81.

The first probe measuring the oxygen content 129 can be configured to measure low oxygen concentrations, for example an oxygen concentration less than or equal to 1%. The first probe measuring the oxygen content 129 can be a Zirconia cell probe placed in a mini-oven, for example a MicroPoas cell raised to 600 or 800° C. in a LISO/P mounting from the company Setnag.

The second probe measuring the oxygen content 136 can be configured to measure high oxygen contents, for example comprised between 1% and 21%. The second probe measuring the oxygen content 136 can guarantee safe operation including in the presence of an explosive atmosphere. The second probe measuring the oxygen content 136 can be an XTP601-Ex analyzer from the company Michell Instruments.

The analysis sub-assembly 112 makes it possible in particular to ensure the exclusion of gas from instruments that are not compatible with an explosive atmosphere, for example in particular the first probe measuring the oxygen content 129 and/or the relative humidity probe 128, for example when the second probe measuring the oxygen content 136 detects an oxygen content that can participate in the formation of such an explosive atmosphere. Such exclusion of gas can be carried out by the rise in the oxygen level to data processing means 65 as described below, so as to control the analysis sub-assembly 112, for example the valve 127 and the valve 130. It is thus possible to carry out the exclusion of gas in a secure and guaranteed manner.

The relative humidity probe 128 can be configured to further measure a gas temperature. The relative humidity probe 128 can be configured to measure relative humidity in a range from 0 to 100% and/or a temperature at least between 0 and 60° C. The relative humidity probe 128 can be an HMT363 probe coupled to an HMT360 acquisition unit from the company Vaisala.

The collection sub-assembly 81 thus allows the collection of gas injected into the device, for example towards a single exit point. The collection sub-assembly 81 allows the analysis of gases derived from the three reservoirs and the three reservoir-dosing apparatus or mixer-reservoir connection sections. The collection sub-assembly 81 allows securing the operation of the device by short-circuiting some sensors in the event of an explosive risk, and can have the capacity to purge these sensors. The collection sub-assembly 81, and more generally the device, through its check valves and filters, allows retention of undesirable powders and protection against counter-current contamination. The collection sub-assembly 81 can also participate, for example with the distribution sub-assembly 74, the pairs of valves 107A-119A, 107B-119B and 109-121, in the selective inerting of the first reservoir 2A—first dosing apparatus 3A, second reservoir 2B—second dosing apparatus 3B and mixer 4—third reservoir 2C connection sections, which otherwise could remain dead volumes whose inerted or non-inerted state, may be unknown in some operating phases.

### Configurations of the Collection Sub-Assembly

As illustrated in FIG. 12b, during normal operation, the collection sub-assembly 81 can have a first configuration in which the probe 136, for example Atex explosive atmosphere compliant, can be exposed to gas to ensure a safety monitoring role, and the probes 128, 129, for example Atex non-compliant, can be exposed to gas to take fine measurements, for example so as to allow tracking/traceability of the production. The gas going up some sections can be blocked by one-way elements, such as the pressure relief valve 117 or closed manual valves, for example the valve 126.

As illustrated in FIG. 12c, when either of the probes measuring the oxygen content 129 and/or 136 measures an oxygen content greater than an explosive risk threshold, the collection sub-assembly 81 can adopt, for example on instruction from the control means, a second configuration isolating the Atex non-compliant elements from the gas potentially carrying a mixture of powder and explosive oxygen. The pressure gauge 131 can remain exposed to the gas when the pressure gauge 131 is a mechanical pressure gauge. The second configuration can be a startup configuration of the device. The obtaining method as described below can comprise a step of powering up the device. During power up, the oxygen content is not necessarily known and it is therefore not necessarily possible to assess the risk of explosiveness. The second configuration can thus be such that the relative humidity probe 128 and/or the first probe measuring the oxygen content 129 is or are isolated, for example as long as the second probe measuring the oxygen content 136, for example Atex compliant, did not allow the control means to confirm that the relative humidity probe 128 and/or the first probe measuring the oxygen content 129 can be exposed to the gas. Once the possibility of exposure has been confirmed, the collection sub-assembly 81 can switch to the first configuration.

As illustrated in FIG. 12d, the collection sub-assembly 81 can have a third purge configuration. In the purge configuration, the set of valves 126, 133 makes it possible to purge the relative humidity probe 128 and/or the first probe measuring the oxygen content 129, for example of accumulated pollutants or of a gas loaded with powder and/or oxygen trapped between the isolation valves 126 and 133. The purge configuration can be configured to circulate a gas, forming a safety gas, for example safe and clean, coming directly from the inert gas network 67, for example via the external supply network 67, the gas inlet 75, the gas outlet 77, the distribution sub-assembly 74, the gas outlet 73, and/or the gas inlet 86. Depending on the open or conductive nature against the current or not of the valve 132 and of the flow rate adjustment and monitoring system 135, the safety gas, if it goes up in some sections, would remain blocked by the closed valves. The set of valves used can be manual so as to carry out the purging when the device is not power supplied, so as to avoid the risk of energy input. Furthermore, the closed state of the valves, for example of the solenoid valves can be guaranteed since they can be configured to close by design in the absence of power supply.

The collection sub-assembly 81 can have a fourth configuration that is completely closed when the device is not used.

The vent 92 can comprise an outlet 93, for example towards the atmosphere and/or the external environment. The vent 92 can be adapted to filter, for example by means of filters or a combination of a cyclone separator and of filters, and/or to monitor the gas collected by the collection sub-assembly 81 and provided to the inlet 91, for example before discharging the collected gas, for example into the atmosphere external to the device. The vent 92 can constitute a single gas filtering and/or monitoring point before the outlet of the device.

### Control Means

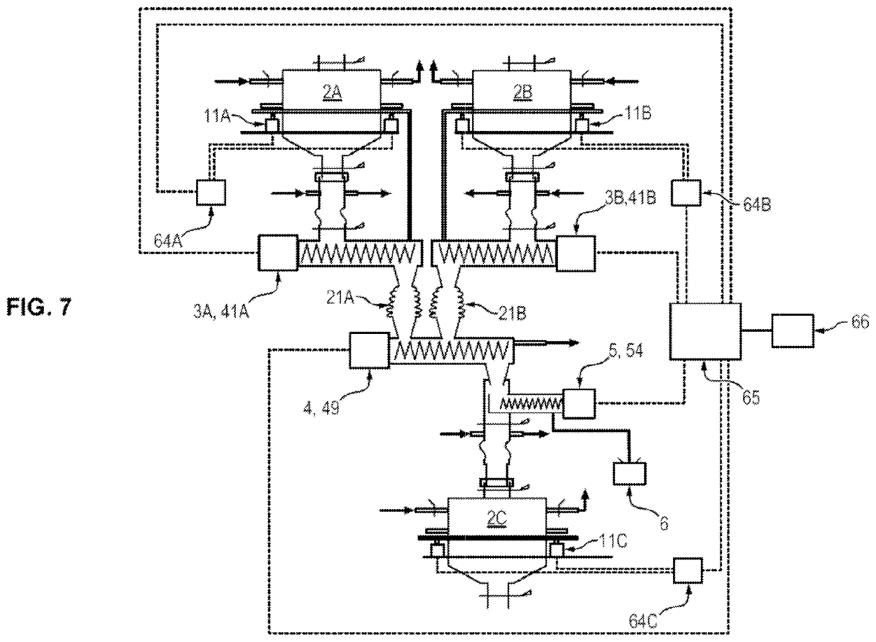

As illustrated in FIG. 7, the device can comprise control means.

The control means can comprise means for controlling the stream of first powder provided by the first dosing apparatus 3A to the mixer 4. The stream of first powder can be a mass flow rate of first powder. The control means can comprise means for controlling the stream of second powder provided by the second dosing apparatus 3B to the mixer 4. The stream of second powder can be a mass flow rate of second powder. The control means can comprise means for controlling a ratio of the stream of first powder and of the stream of second powder. The control means can form a control system, for example servo-control system, of the device.

The device can comprise data processing means 65, for example a data processing unit. The control means can comprise the data processing means 65. The data processing unit can be a PLC. The data processing means 65 can comprise a processor and/or data storage means, for example a memory. The control means can comprise an interface 66. The interface can form a man-machine interface. The interface 66 can comprise means for entering data by an operator and/or display means. The interface can comprise a terminal, for example a touch screen.

The first weighing means, and/or the second weighing means, and/or the third means and/or the first dosing apparatus 3A and/or the second dosing apparatus 3B, and/or the mixer 4 can be interconnected and servo-controlled by the control means, for example to ensure a mixture of the first powder and of the second powder following a mixing setpoint and/or a powder target. The mixing setpoint can be a setpoint of the ratio of the stream of first powder provided by the first dosing apparatus 3A to the mixer 4 and of the stream of second powder provided by the second dosing apparatus 3B to the mixer 4, for example of the mass ratio. The mixing setpoint can be a setpoint to be checked throughout the mixing. The powder target can comprise a target for quantity and/or mass of the first powder used and/or a target for quantity and/or mass of the second powder used and/or a target for quantity and/or mass of the mixed powder produced.

For example, the mixing setpoint can comprise a setpoint of the mass ratio of the stream of first powder provided by the first dosing apparatus 3A to the mixer 4 and of the stream of second powder provided by the second dosing apparatus 3B to the mixer 4, adapted to obtain a mixed powder of Ti-6Al-4V titanium alloy and grade 23 or ELI, when the first powder is a new Ti-6Al-4V titanium alloy powder having an oxygen mass content of 0.11% and when the second powder is a recycled Ti-6Al-4V titanium alloy powder having an oxygen mass content of 0.20%. A powder of Ti-6Al-4V titanium alloy and of grade 23 or ELI must have an average oxygen mass content less than or equal to 0.13%. Thus in this example, the setpoint for the mass ratio of the stream of first powder to the stream of second powder can be for example a ratio 89/11 making it possible to obtain a mixed powder having an oxygen mass content of 0.1199%.

The control means can comprise a first weighing controller 64A. The first weighing controller 64A can be connected to the first weighing means. The first weighing controller 64A can be configured to estimate, for example continuously, a first mass from data derived from the first weighing means. The first weighing controller 64A can be configured to estimate, for example by time derivation of the first estimated mass, the stream of first powder provided by the first dosing apparatus 3A to the mixer 4. The stream of first powder can be a mass flow rate of first powder. The first weighing controller 64A can be configured to transmit the first mass and/or the stream of first powder is/are communicated to the data processing means 65.

The control means can comprise a second weighing controller 64B. The second weighing controller 64B can be connected to the second weighing means. The second weighing controller 64B can be configured to estimate, for example continuously, a second mass from data derived from the second weighing means. The second weighing controller 64B can be configured to estimate, for example by time derivation of the second estimated mass, the stream of second powder provided by the second dosing apparatus 3B to the mixer 4. The stream of second powder can be a mass flow rate of second powder. The second weighing controller 64B can be configured to transmit the second mass and/or the stream of second powder is/are communicated to the data processing means 65.

The control means can comprise a third weighing controller 64C. The third weighing controller 64C can be connected to the third weighing means. The third weighing controller 64C can be configured to estimate, for example continuously, a third mass from data derived from the third weighing means. The third weighing controller 64C can be configured to estimate, for example by time derivation of the third estimated mass, the stream of third powder provided by the mixer 4 to the third reservoir 2C. The stream of third powder can be a mass flow rate of third powder. The third weighing controller 64C can be configured to transmit the third mass and/or the stream of third powder is/are communicated to the data processing means 65.

The data processing means 65 can be configured to drive the first motor group 41A and/or the second motor group 41B for example in order to regulate the ratio of the stream of first powder provided by the first dosing apparatus 3A to the mixer 4 and of the stream of second powder provided by the second dosing apparatus 3B to the mixer 4. The data processing means can be configured to drive the first motor group 41A in motor speed, and/or the second motor group 41B in drive speed.

The mixing setpoint can be determined beforehand, for example previously stored by the data processing means 65. The mixing setpoint can be entered by an operator via the interface 66.

The data processing means 65 can be configured to drive the third motor group 49 for example in order to regulate the stream of mixed powder provided by the mixer 4. The data processing means can be configured to drive the third motor group 49 in motor speed. The driving of the third motor group 49 by the data processing means 65 can be an all-or-nothing driving.

The driving(s) of the first motor group 41A and/or of the second motor group 41B and/or of the third motor group 49 may depend on the first estimated mass and/or on the second estimated mass and/or on the third estimated mass, for example to determine the starting and/or stopping of the first motor group 41A and/or of the second motor group 41B and/or of the third motor group 49. The rotation and holding in rotation of the first motor group 41A and/or of the second motor group 41B can thus be conditioned to the measurement of a first mass greater than a first rotation threshold. It is thus possible to start only when the quantity of powder in the reservoir is sufficient and/or to stop the device when the quantity of powder becomes insufficient. The rotation and holding in rotation of the first motor group 41A and/or of the second motor group 41B can thus be conditioned on the measurement of a second mass greater than a second rotation threshold. It is thus possible to start only when the quantity of powder in the reservoir is sufficient and/or the stopping of the rotation of the third motor group 49 can be triggered when the third estimated mass is greater than a third rotation threshold.

The data processing means 65 can also be configured to trigger the sampling(s) of a fraction of the stream of powder mixed by the sampler 5. The samplings can be triggered periodically during the operation of the mixer 4, and/or when the third estimated mass crosses a sampling threshold, for example a threshold of a plurality of sampling thresholds, each crossing of such a threshold causing a sampling. The sampling threshold can be lower than the third threshold.

The control means can comprise means for transmitting data to a remote network. The remote data transmission means can be means for transmitting data via a wired and/or wireless network, for example cellular network. By “remote”, it is meant which is not included in the device. The remote network can be a local network for supervising the infrastructure that accommodates the device, a remote database in a third-party and off-site company network for example that can be reached via the internet, for example via a cellular and/or or cable network.

The first weighing controller 64A and/or the second weighing controller 64B and/or the third weighing controller 64C can be one or more Scaime eNod4-F digital conditioners.

### Tracking/Traceability

The device can be configured to track the mixing of the first stored powder and/or of the second stored powder to obtain the stored mixed powder. The device can be configured to track mixing operations performed by the device. The data processing means 65 can be configured to implement the tracking. The tracking can comprise the tracking of the quantity of the first powder in the reservoir 2A, and/or of the second powder in the reservoir 2B, and/or of the third powder in the reservoir 2C. The tracking can comprise the tracking of the streams of new powder and/or of recycled powder and/or of mixed powder in the device. The tracking can comprise the tracking of the physical characteristics of the gas in the device, such as the pressure and/or the oxygen content and/or the humidity content.

The tracking can comprise obtaining and recording, over time, by the data processing means 65, oxygen content and/or humidity and/or pressure values associated with the gas in the device. The tracking can comprise obtaining and recording, over time, by the data processing means 65, powder mass and/or powder mass flow rates values associated with the stored and mixed powder(s).

The data processing means 65 can be configured to implement the tracking. The tracking can comprise the tracking of the quantity of first powder stored in the first reservoir 2A and in the dosing apparatus 3A. The tracking can comprise the tracking of the mass flow rate of powder leaving the first reservoir 2A and the dosing apparatus 3A. The tracking can thus comprise obtaining and recording over time, by the data processing means 65, powder mass and powder mass flow rate values associated with the powder stored in the first reservoir 2A and in the dosing apparatus 3A. The mass and mass flow rate values associated with the first powder can be obtained from measurements and estimations performed by weighing means, for example by the first weighing cell(s) 11A and the weighing controller 64A.

The tracking can comprise the tracking of the quantity of second powder stored in the second reservoir 2B and in the dosing apparatus 3B. The tracking can comprise the tracking of the mass flow rate of powder leaving the second reservoir 2B and the dosing apparatus 3B. The tracking can thus comprise obtaining and recording over time, by the data processing means 65, powder mass and powder mass flow rate values associated with the powder stored in the second reservoir 2B and in the dosing apparatus 3B. The mass and mass flow rate values associated with the second powder can be obtained from measurements and estimations performed by weighing means, for example by the second weighing cell(s) 11B and the weighing controller 64B.

The tracking can comprise the tracking of the quantity of third powder stored in the third reservoir 2C. The tracking can comprise the tracking of the mass flow rate of powder entering the third reservoir 2C. The tracking can thus comprise obtaining and recording over time, by the data processing means 65, powder mass and powder mass flow rate values associated with the powder stored in the third reservoir 2C. The mass and mass flow values associated with the third powder can be obtained from measurements and estimations performed by weighing means, for example by the third weighing cell(s) 11C and the weighing controller 64C.

The tracking can comprise the tracking of the pressure and/or oxygen content and/or humidity content of the gas in the device. The pressure and/or oxygen content and/or humidity content values can be obtained from measurements made at one or more points of the device. The humidity content values can be obtained from measurements made and transmitted by a probe measuring the relative humidity, for example the relative humidity probe 128. The oxygen content values can be obtained from measurements made and transmitted by a probe measuring the oxygen content of the gas, for example the first probe measuring the oxygen content 129 and/or the second probe measuring the oxygen content 136. The pressure values associated with the first powder can be obtained from measurements made and transmitted by a pressure sensor, for example the pressure sensor 111 and/or the pressure sensor 97 and/or the pressure sensor 116 and/or the pressure sensor 131.

The data processing means 65 can be configured to perform a recording of the setpoint data entered by the operators, for example by means of the interface 66, particularly the ratio setpoint of the stream of first powder provided by the first dosing apparatus 3A to the mixer 4 and of the stream of second powder provided by the second dosing apparatus 3B to the mixer 4, for example of the mass ratio.

The data processing means 65 can be configured to track the states of the elements of the device that are controlled by the control means and/or setpoints issued by the control means and/or feedbacks provided by the elements of the device thus controlled by the setpoints. The data processing means 65 can be configured to transfer the data collected during the tracking into remote data storage means, for example by means of the data transmission means of the data processing means 65. The data derived from the tracking of a mixing operation can be virtually associated with the mixed powder resulting from the mixing operation, for example by means of a unique identification number of said mixed powder serving as a pairing key.

### Exemplary Embodiments

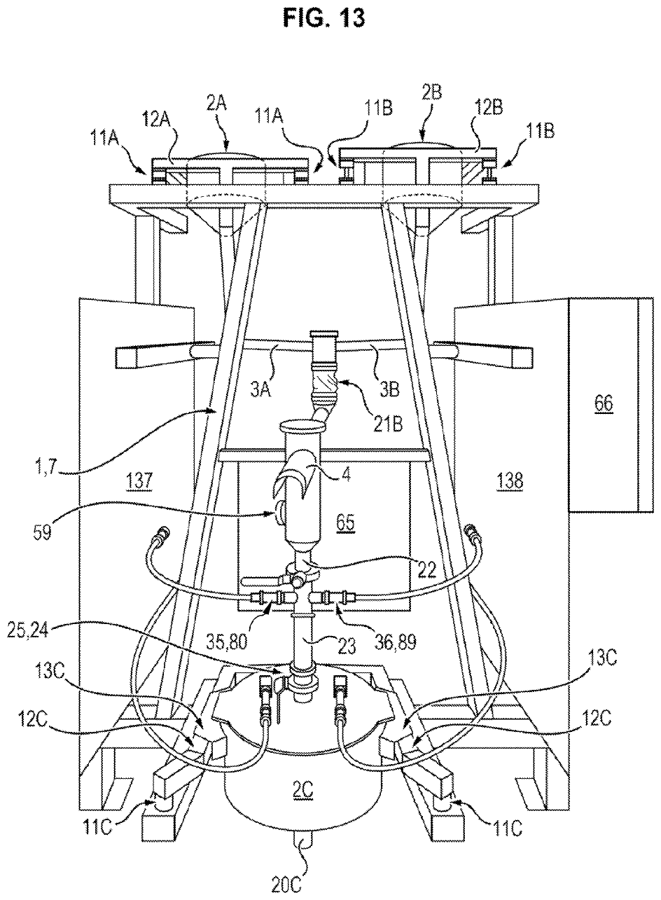

FIGS. 13 to 16 reproduce an example of the device corresponding to that of FIGS. 1 to 12. FIG. 13 is a side view of the third reservoir 2C for the mixed powder, in the configuration where the first reservoir 2A, the second reservoir 2B and the third reservoir 2C rest on their accommodation cradle 12A, 12B, and 12C respectively, and where the third reservoir 2C is in fluid connection with the mixer 4 via the flexible element 23. The sampler 5 is not mounted on this image, but the mounting flange 59 is visible. The first reservoir 2A can rest on the first accommodation cradle 12A, the first cradle 12B being for example rigidly linked to the dosing apparatus 3A. The first reservoir 2A can be fluidly connected to the first dosing apparatus 3A. The second reservoir 2B can rest on the second accommodation cradle 12B, the second cradle 12B being for example rigidly linked to the second dosing apparatus 3B. The second reservoir 2B can be fluidly connected to the second dosing apparatus 3B. The third reservoir 2C can rest on the third accommodation cradle 12C. The mixer 4 can be fluidly connected to the third reservoir 12C, and cannot be in rigid connection with the third cradle 12C and/or the first dosing apparatus 3A and/or the second dosing apparatus 3B.

The two gas plates or gas panel 138 and 139 support all or part of the expansion 68, distribution 69 and collection 81 sub-assemblies.

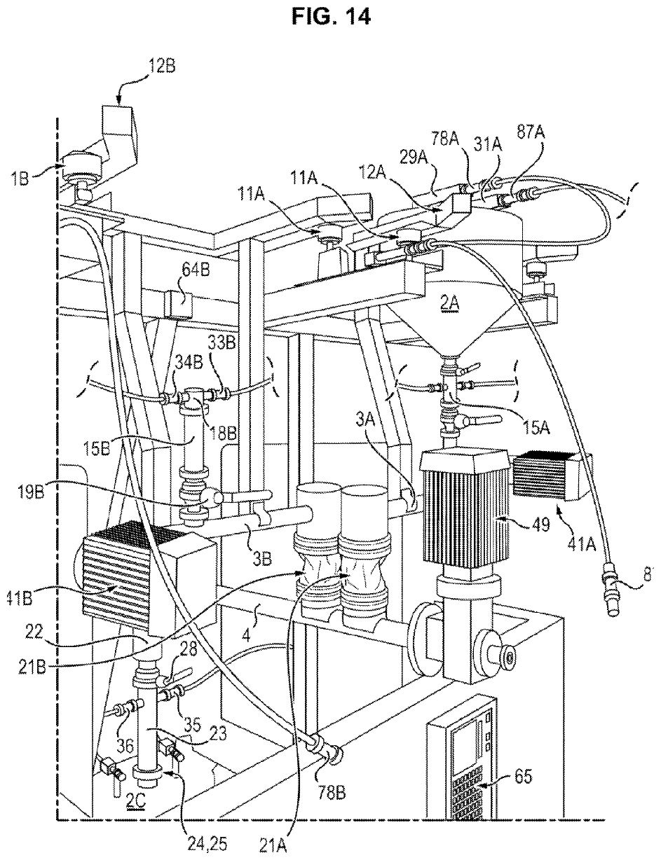

FIG. 14 is a view from the opposite side to that of FIG. 13 that is to say on the side of the first reservoir 2A for the first powder, for example new powder, and of the second reservoir 2B for the second powder, for example recycled powder. In the configuration presented, the second reservoir 2B is not installed: part of the connectors or sets of connections, for example the connector 87B, is therefore shown disconnected.

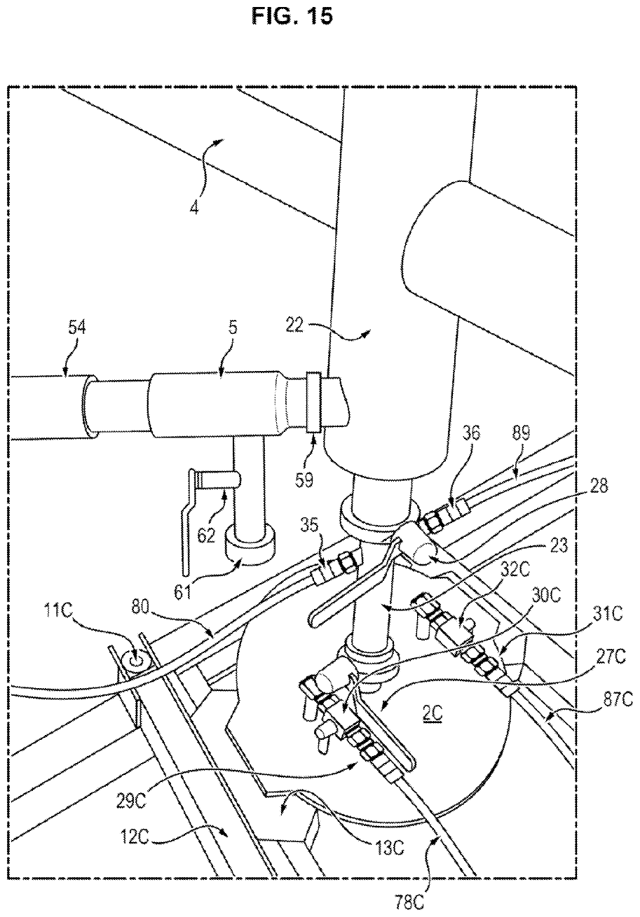

FIG. 15 is a view from above of the third reservoir 2C, which also shows the sampler 5 mounted.

FIG. 16 is a detailed view of the connection between the first dosing apparatus 3A, the second dosing apparatus 3B and the mixer 4, by means of the transparent bellows 21A and 21B making it possible to avoid the transfer of the weighing forces between the first and second dosing apparatuses 3A and 3B and the mixer 4.

### Method

### General Description of the Method

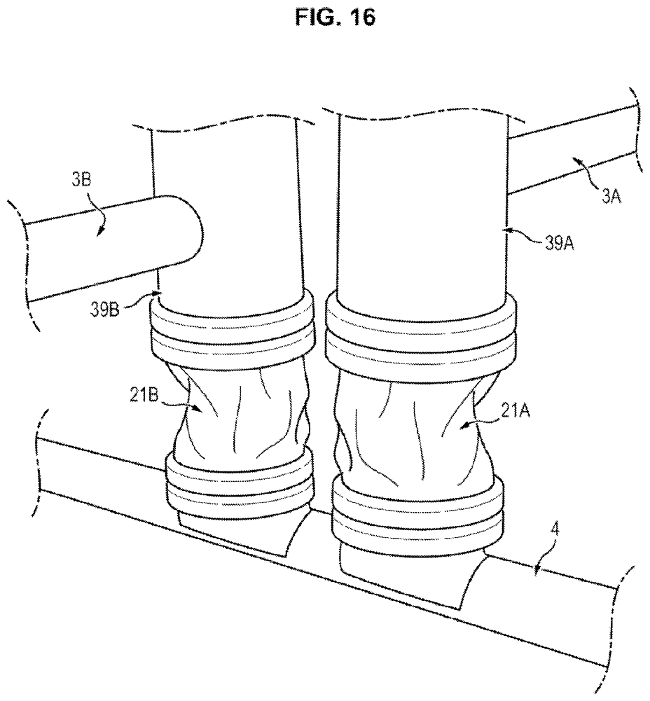

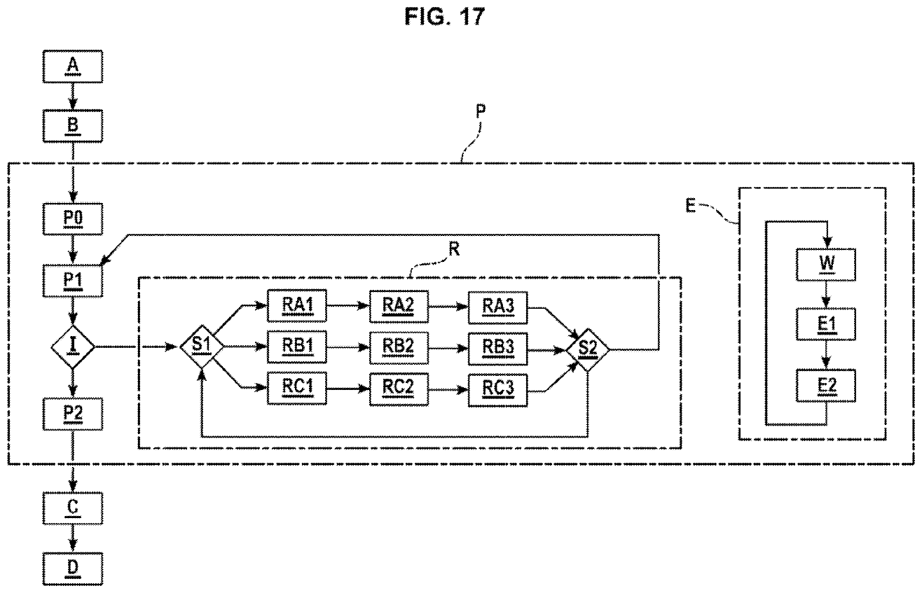

FIG. 17 illustrates a method for obtaining the mixed powder. The obtaining method can be implemented by means of the device.

The obtaining method can comprise the continuous mixing of the first powder and of the second powder, implemented by means of the device.

The method can comprise the continuous dosing of the first powder by the first dosing apparatus 3A and the continuous dosing of the second powder by the second dosing apparatus 3B, for example simultaneously with the dosing of the first powder.

The method can comprise, for example simultaneously with the dosing, the mixing by the mixer 4 of the first powder dosed by the first dosing apparatus and of the second powder dosed by the second dosing apparatus, so as to provide a continuous stream of powder mixed according to a determined ratio.

The method can comprise the sampling of a fraction of the stream of mixed powder by the sampler 5. The sampling can be repeated several times, for example periodically.

With reference to FIG. 17, a method P for producing the mixed powder is described. The obtaining method can comprise a step P of producing the mixed powder, the production step P comprising the production method P.

The production method P can comprise a step P1 of mixing the first powder and the second powder. Step P1 can be a step of dosing and mixing the first powder and the second powder with sampling. Step P1 can comprise the tracking as described above. Step P1 can be implemented under sweeping of the device by the inerting gas.

The production method P can comprise a step P0 of loading dosing apparatus(es), for example the first dosing apparatus 3A and the second dosing apparatus 3B. Step P0 can comprise the tracking as described above. The loading of dosing apparatus(es) can be carried out under sweeping by the inerting gas, for example under sweeping of the first dosing apparatus 3A and of the second dosing apparatus 3B by the inerting gas. The loading step P0 can be implemented before step P1.

The production method P can comprise a production completion step P2. Step P2 can be implemented with sampling. Step P2 can comprise the tracking as described above, for example the tracking of the end of production. Step P2 can be implemented under sweeping of the device by the inerting gas. Step P2 can be implemented subsequently to step P1.

With reference to FIG. 17, a method R for replacing a reservoir is described, for example the first reservoir 2A and/or the second reservoir 2B and/or the third reservoir 2C. The production method P can comprise a reservoir replacement step R comprising the reservoir replacement method R.

With reference to FIG. 17, a method E for operating the sampler 5 is described. The mixing method, for example the production method P, can comprise a sampler operating step comprising the sampler 5 operating method E. The sampler 5 operating method E can be an operating cycle E of the sampler 5.

The obtaining method can comprise a content setting step B. The content setting step B can be implemented prior to the production method P.

The obtaining method can comprise a step A of installing reservoir(s), for example of installing the first reservoir 2A and/or the second reservoir 2B and/or the third reservoir 2C. The reservoir installation step A can be implemented prior to the content setting step B.

The obtaining method can comprise a stopping step C. The stopping step C can be implemented subsequently to the production method P.

The obtaining method can comprise a step of depositing reservoir(s) D, for example depositing the first reservoir 2A and/or the second reservoir 2B and/or the third reservoir 2C. The reservoir deposition step D can be implemented subsequently to the stopping step C.

The obtaining method can be carried out semi-automatically, for example by means of a combination of automatic actions carried out by the control means, for example by the data processing means 65 and of manual actions of one or more operator(s) of the device, for example of manual actions for opening and/or closing valves of the device, and/or for example of manual actions for driving the control means, for example via the interface 66.

By “opening an element, for example a valve”, it is meant for example both the action of opening and maintaining said element, for example said valve, in the open state.

By “closing an element, for example a valve”, it is meant for example both the action of closing and maintaining said element, for example said valve, in the closed state.

### Sampler Operating Method

The sampler 5 operating method E can comprise a sampling step E1, for example so as to discharge into the container 6 a portion of the powder stream circulating from the mixer 4 to the third reservoir 2C. The sampling step E1 can comprise the rotation of the fourth screw 53 of the sampler 5 in a first direction in order to discharge into the sample container 6 the portion of the powder stream circulating from the mixer 4 towards the third reservoir 2C.

The sampler 5 operating method E can comprise a step E2 of purging the sampler 5, for example implemented subsequently to the sampling step E1, for example in order to release any remainder of intercepted mixed powder. The purging step E2 can comprise the rotation of the fourth screw 53 in a second direction, for example opposite to the first direction, in order to release any remainder of intercepted mixed powder remaining in the sampler body 52 via the mixed powder reintroduction outlet 58.

The sampler 5 operating method E can comprise a waiting step W, for example implemented subsequently to the purging step E2. During the waiting step W, the sampler 5 can be inactive. The waiting step W can end after a predetermined period, for example by means of a time delay, and/or when the third estimated mass of the third reservoir 2C is greater than a predetermined threshold. The end of the waiting step W can cause the implementation of the sampling step E1, for example, once again.

### First Powder and Second Powder Mixing Step

The first powder and second powder mixing step P1 can be implemented continuously. The mixing step P1 can comprise the continuous simultaneous dosing, for example of the first powder, for example according to the mixing setpoint of the first powder contained in the first reservoir 2A by the first dosing apparatus 3A and of the second powder contained in the second reservoir 2B by the dosing apparatus 3B.

Simultaneously with the dosing, the mixing step P1 can comprise the continuous mixing, by the mixer 4, of the first powder dosed by the first dosing apparatus 3A and of the second powder dosed by the second dosing apparatus 3B, for example so as to provide a continuous stream of mixed powder, for example according to the mixing setpoint. The continuous stream of mixed powder can be discharged into the third reservoir 2C.

Simultaneously with the mixing step P1, the sampler 5 operating method E can be implemented.

The sweeping by the inerting gas during the mixing step P1 can be carried out with the inerting gas derived from the inert gas network 67. The sweeping by the inerting gas can comprise the sweeping of the first reservoir 2A and/or of the second reservoir 2B and/or of the third reservoir 2C and/or of the first dosing apparatus 3A and/or of the first dosing apparatus 3B and/or of the mixer 4 and/or of the fluid connection means between the first reservoir 2A and the first dosing apparatus 3A, and/or of the fluid connection means between the second reservoir 2B and the second dosing apparatus 3B, and/or of the fluid connection means between the mixer 4 and the third reservoir 2C.

The first outlet valve 20A and/or the second outlet valve 20B and/or the first upstream valve 19A and/or the second upstream valve 19B and/or the third upstream valve 28 and/or the third inlet valve 27C can be opened during step P1. It is thus possible to allow the circulation of the powders.

The sweeping can be carried out by opening the valves 95 and/or 102A and/or 102B and/or 105 and/or 134 and/or the tapping valve 30A of the first reservoir, and/or the tapping valve 30B of the second reservoir, and/or the tapping valve 32A of the first reservoir, and/or the tapping valve 32B of the second reservoir and/or the tapping valve 32C of the third reservoir throughout the duration of step P1.

The valves 107A and/or 107B and/or 109 and/or 119A and/or 119B and/or 121 can be closed for the entire duration of step P1, for example to avoid disruption of the stream of powder circulating through the fluid connection means between the first reservoir 2A and the first dosing apparatus 3A and/or between the first reservoir 2B and the first dosing apparatus 3B and/or between the mixer 4 and/or the third reservoir 2C.

### Loading Step

The loading step P0 can comprise the rotation, for example simultaneously or sequentially, for example without discharging powder into the mixer 4, for example independently of the mixing setpoint, of the first screw 40A of the first dosing apparatus 3A to load the first dosing apparatus 3A with first powder derived from the first reservoir 2A and/or of the second screw 40B of the second dosing apparatus 3B to load the second dosing apparatus 3B with second powder derived from the second reservoir 3A.

The sweeping by the inerting gas during the loading step P0 can be carried out with the inerting gas derived from the inert gas network 67. The sweeping by the inerting gas can comprise the sweeping of the first reservoir 2A and/or or of the second reservoir 2B and/or of the third reservoir 2C and/or of the first dosing apparatus 3A and/or of the first dosing apparatus 3B and/or of the mixer 4 and/or of the fluid connection means between the first reservoir 2A and/or of the fluid connection means between the first dosing apparatus 3A, and/or of the fluid connection means between the second reservoir 2B and the second dosing apparatus 3B, and/or of the fluid connection means between the mixer 4 and the third reservoir 2C.

Step P0 can be completed for example manually by an operator of the device, or end after a predetermined period, for example by means of a time delay.

The loading step P0 allows better compliance with the mixing setpoint in the first moments of step P1. Indeed, if step P0 is not executed, a certain time can elapse between the actuation of the first dosing apparatus 3A and/or of the second dosing apparatus 3B, and the discharge of the first powder and/or of the second powder in the mixer 4. During this interval, the weight measured by the first weighing cell(s) 11A does not vary, and/or the weight measured by the second weighing cell(s) 11B does not vary. The control means, for example the data processing means 65, therefore cannot have a correct estimation of the mass flow rate of the first powder and/or of the mass flow rate of the second powder, and therefore cannot ensure the regulation in mass flow rate of the first dosing apparatus 3A and/or of the second dosing apparatus 3B.

To allow the circulation of powders, the first outlet valve 20A and/or the second outlet valve 20B and/or the first upstream valve 19A and/or the second upstream valve 19B can be opened for the entire duration of the loading step P0. Additionally, to allow the circulation of the inerting gas, the third upstream valve 28 and/or the third inlet valve 27C can be opened during step P0.

The sweeping can be carried out by opening the valves 95 and/or 102A and/or 102B and/or 102C and/or 105 and/or 134 and/or the tapping valve 30A of the first reservoir, and/or the tapping valve 30B of the second reservoir, and/or the tapping valve 30C of the third reservoir, and/or the tapping valve 32A of the first reservoir, and/or the tapping valve 32B of the second reservoir and/or the tapping valve 32C of the third reservoir for the entire duration of step P0.

The valves 107A and/or 107B and/or 109 and/or 119A and/or 119B and/or 121 can be closed for the entire duration of step P0, for example to avoid disruption of the stream of powder circulating through the fluid connection means between the first reservoir 2A and the first dosing apparatus 3A and/or between the first reservoir 2B and the first dosing apparatus 3B and/or between the mixer 4 and/or the third reservoir 2C.

### Interruption I

The production method P can comprise an interruption I, for example the interruption of the mixing step P1.

The interruption I can be triggered when the first estimated mass of first powder in the first reservoir 2A, in the first dosing apparatus 3A and in the fluid connection means between the first reservoir 2A and the first dosing apparatus 3A is lower than or equal to a first interruption threshold. It is thus possible to interrupt the mixing step P1 when the remaining mass of first powder is lower than or equal to this first interruption threshold, for example when the first reservoir 2A no longer contains the first powder. The interruption I can be triggered when the second estimated mass of the second powder in the second reservoir 2B, in the second dosing apparatus 3B and in the fluid connection means between the second reservoir 2B and the second dosing apparatus 3B is lower than or equal to a second interruption threshold. It is thus possible to interrupt the mixing step P1 when the remaining mass of the second powder is lower than or equal to this second interruption threshold, for example when the second reservoir 2B no longer contains the second powder.

The interruption I can be triggered when the third estimated mass of the third powder mixed in the third reservoir 2C is lower than or equal to a third interruption threshold. It is thus possible to interrupt the mixing step P1 when the mass of the third powder contained in the third reservoir 2C is higher than or equal to this third interruption threshold, for example when the sum of the mass of the third powder contained in the third reservoir 2C and of the mass of the powder contained in the mixer 4 is equal to produced mixed powder target, for example comprised in the powder target.

The interruption I can be followed by the production completion step P2, possibly with sampling and tracking and under inerting sweeping. The interruption I can also be followed by the reservoir replacement method R.

The interruption I can end by intervention of an operator of the device, for example by the selection by an operator of the device by means of the interface 66 of a continuation of the production method P by a production completion step P2, or of a continuation of the production method P by a reservoir replacement step R.

The interruption I can comprise the implementation of the tracking as described above.

The interruption I can comprise an interruption of the sweeping by the inerting gas, for example by closing the valves 102A and/or 102B and/or 102C and/or 105 and/or 134.

### Production Completion Step

The production completion step P2 can comprise the mixing, by the mixer 4, of the quantity of the first powder contained in the mixer 4 and of the quantity of the second powder contained in the mixer 4, so as to provide a stream of mixed powder according to the mixing setpoint and to discharge it into the third reservoir 2C.

Simultaneously with step P2, the sampler 5 operating method E can be implemented.

The sweeping by the inerting gas during the production completion step P2 can be carried out with the inerting gas derived from the inert gas network 67. The sweeping by the inerting gas can comprise the sweeping of the third reservoir 2C and/or of the first dosing apparatus 3A and/or of the first dosing apparatus 3B and/or of the mixer 4 and/or of the fluid connection means between the mixer 4 and the third reservoir 2C.

Step P2 can end after a predetermined period, for example by means of a time delay and/or for example manually by an operator of the device, and/or for example when the estimated mass of the third powder contained in the third reservoir 2C is greater than or equal to a fourth interruption threshold, for example equal to a produced mixed powder target, for example comprised in the powder target.

During the production completion step P2, to interrupt the discharge of the first powder from the first reservoir 2A into the first dosing apparatus 3A and/or of the second powder from the second reservoir 2B into the second dosing apparatus 3B, the first outlet valve 20A and/or the second outlet valve 20B can be closed throughout step P2.

To allow the discharge of mixed powder from the mixer 4 into the third reservoir 2C, the third upstream valve 28 and/or the third inlet valve 27C can be opened throughout step P2.

The sweeping during step P2 can be carried out by opening the valves 95 and/or 105 and/or 107A and/or 107B and/or 134 and/or the tapping valve 32C of the third reservoir for the entire duration of step P2.

The valves 109 and/or 121 can for example be closed for the entire duration of step P2, for example to avoid disruption of the stream of powder circulating through the fluid connection means between the mixer 4 and/or the third reservoir 2C.

### Reservoir Installation Step

The reservoir installation step A can comprise the placement of the first reservoir 2A containing a quantity, for example non-zero quantity, of the first powder, for example new powder, on the first accommodation cradle 12A. The first reservoir 2A may enclose an inerting gas in addition to the first powder, or the first reservoir 2A may not enclose any inerting gas.

The reservoir installation step A can comprise the placement of the second reservoir 2B containing a quantity, for example non-zero quantity, of the second powder, for example recycled powder, on the second accommodation cradle 12B. The second reservoir 2B may enclose an inerting gas in addition to the second powder, or the second reservoir 2B may not enclose any inerting gas.

The reservoir installation step A can comprise the placement of the third reservoir 2C, for example not containing the powder, on the third accommodation cradle 12C. The third reservoir 2C may or may not enclose an inerting gas.

The reservoir installation step A can comprise the fluid connection of the first reservoir 2A, and/or of the second reservoir 2B, and/or of the third reservoir 2C, to the device. The fluid connection can comprise the connection of the connector 78A to the gas inlet tapping 29A and of the connector 87A to the gas outlet tapping 31A, and of the first outlet duct 17A of the first reservoir 2A to the first rigid part 16A by locking the first flange 18A, and/or the connection of the connector 78B to the gas inlet tapping 29B and of the connector 87B to the gas outlet tapping 31B, and of the second duct 17B of the second reservoir 2B to the second rigid part 16B by locking the second flange 18B, and/or the connection of the connector 78C to the gas inlet tapping 29C and of the connector 87C to the gas outlet tapping 31C, and the of third inlet duct 26C of the third reservoir 2C to the third rigid part 24 by locking the third flange 25.

All valves of the device can be closed throughout the duration of step A.

### Content Setting Step

The content setting step B can comprise a temporary, sequential or simultaneous sweeping, and commonly or separately, of the first reservoir 2A, and/or of the second reservoir 2B, and/or of the third reservoir 2C, and/or of the first dosing apparatus 3A, and/or of the second dosing apparatus 3B, and/or of the mixer 4, and/or of the fluid connection means between the first reservoir 2A and the first dosing apparatus 3A, and/or of the fluid connection means between the second reservoir 2B and the second dosing apparatus 3B, and/or of the fluid connection means between the mixer 4 and the third reservoir 3C.

By “temporary”, it is meant for example that the sweeping begins during step B and ends during the same step B.

The end of step B and the end of the corresponding sweeping can be conditioned on the measurement by the first probe measuring the oxygen content 129 and/or by the second probe measuring the oxygen content 136, of an oxygen content lower than a certain threshold, for example less than 2%, for example less than 0.5%, in the sweeping gas collected by the collection sub-assembly 81.

The end of step B and the end of the corresponding sweeping can be conditioned on the measurement by the relative humidity probe 128 of a relative humidity lower than a certain threshold, for example lower than 3%, in the sweeping gas collected by the collection sub-assembly 81.

It is thus possible to bring the internal atmosphere to any point of the first reservoir 2A, and/or of the second reservoir 2B, and/or of the third reservoir 2C, and/or of the first dosing apparatus 3A, and/or of the second dosing apparatus 3B, of the mixer 4, and/or of the fluid connection means between the first reservoir 2A and the first dosing apparatus 3A, and/or of the fluid connection means between the second reservoir 2B and the second dosing apparatus 3B, and/or of the fluid connection means between the mixer 4 and the third reservoir 3C, in a known and safe state from the point of view of the explosive risk and from the point of view of maintaining the quality of the powders, before the start of the dosing and mixing operations.

At least some of the valves allowing the circulation of the powders, for example the first outlet valve 20A and/or the second outlet valve 20B and/or the third outlet valve 20C and/or the first inlet valve 27A and/or the second inlet valve 27B and/or the third inlet valve 27C can be closed throughout the duration of step B. The first upstream valve 19A and/or the second upstream valve 19B and/or the third upstream valve 28 can also be opened throughout the duration of step B.

A beginning of the sweeping of step B can be carried out by opening the valves 95 and/or 102A and/or 102B and/or 102C and/or 105 and/or 134 and/or the tapping valve 30A of the first reservoir, and/or the tapping valve 30B of the second reservoir, and/or the tapping valve 30C of the third reservoir, and/or the valves 107A and/or 107B and/or 121 and/or the tapping valve 32A of the first reservoir, and/or the tapping valve 32B of the second reservoir and/or the tapping valve 32C of the third reservoir.

A stopping of the sweeping of step B can be carried out for example by closing the valves 102A and/or 102B and/or 102C and/or 105 and/or 134.

### Stopping Step

The stopping step C can comprise the closing of all the valves of the device and the powering off of the device.

### Reservoir Deposition Step

The reservoir deposition step D can comprise the fluid disconnection of the first reservoir 2A, and/or of the second reservoir 2B and/or of the third reservoir 2C from the device. For example, the fluid disconnection can comprise the separation of the connector 78A and the gas inlet tapping 29A, of the connector 87A and the gas outlet tapping 31A, and of the first outlet duct 17A of the first reservoir 2A and the first rigid part 16A by the unlocking of the first flange 18A and/or the separation of the connector 78B and the gas inlet tapping 29B, of the connector 87B and the gas outlet tapping 31B, and of the second duct 17B of the second reservoir 2B and the second rigid part 16B by the unlocking of the second flange 18B and/or the separation of the connector 78C and the gas inlet tapping 29C, of the connector 87C and the gas outlet tapping 31C, and of the third inlet duct 26C of the third reservoir 2C and the third rigid part 24 by the unlocking of the third flange 25.

The reservoir deposition step D can comprise the deposition of the first reservoir 2A out of the first accommodation cradle 12A, and/or the deposition of the second reservoir 2B out of the second accommodation cradle 12B, and/or the deposition of the third reservoir 2C out of the third accommodation cradle 12C.

All the valves of the device can be closed throughout the duration of step D.

### Reservoir Replacement Method

The reservoir replacement method R can comprise a first selection step S1.

The first selection step S1 can comprise the selection, for example by an operator of the device and/or by the control means, of a reservoir to be replaced, for example among the first reservoir 2A, the second reservoir 2B and the third reservoir 2C.

For example, the first reservoir 2A can be selected if it contains an insufficient quantity of first powder to continue the dosing and mixing operation of step P1. For example, the second reservoir 2B can be selected if it contains an insufficient quantity of second powder to continue the dosing and mixing operation of step P1. For example, the third reservoir 3C can be selected if it contains a maximum capacity of third powder while the target powder, for example, the target quantity of third powder to be produced, has not been reached.

### First Reservoir Replacement

The first selection step S1 can result in the selection of the first reservoir 2A. The reservoir replacement method R can then comprise a step RA1 of fluidly isolating the first reservoir 2A, subsequently to the first selection step S1.

The step RA1 of fluidly isolating the first reservoir 2A can comprise the closing of the first upstream valve 19A and/or of the first outlet valve 20A, and/or of the tapping valve 30A of the first reservoir and/or of the tapping valve 32A of the first reservoir and/or of the valve 107A.

The reservoir replacement method R can then comprise a first reservoir substitution step RA2. The step RA1 of fluidly isolating the first reservoir 2A can be followed by the step RA2 of substituting the first reservoir.

The first reservoir substitution step RA2 can comprise the separation of the first reservoir 2A from the device, for example the separation of the connector 78A and the gas inlet tapping 29A, of the connector 87A and the gas outlet tapping 31A, and of the first outlet duct 17A of the first reservoir 2A and the first rigid part 16A by the unlocking of the first flange 18A.

The first reservoir substitution step RA2 can comprise the withdrawal of the first reservoir 2A out of the first accommodation cradle 12A, and the deposition on the first accommodation cradle 12A of another first reservoir 2A containing a non-zero quantity of the first powder.

The first reservoir substitution step RA2 can comprise the reestablishment of the connection of the first reservoir 2A to the device, for example the connection of the connector 78A to the gas inlet tapping 29A and of the connector 87A to the gas outlet tapping 31A, and of the first outlet duct 17A of the first reservoir 2A to the first rigid part 16A by the locking of the first flange 18A.

The reservoir replacement method R can then comprise a step RA3 of setting the content of the first reservoir. The first reservoir replacement Step RA2 can be followed by step RA3 of setting the content of the first reservoir.

The step RA3 of setting the content of the first reservoir can comprise the temporary sweeping using inert gas derived from the supply network 67, of the first reservoir 2A and of the fluid connection means between the first reservoir 2A and the first dosing apparatus 3A.

By “temporary”, it is meant that the sweeping begins during step RA3 and ends during step RA3.

The end of the sweeping and the end of step RA3 can be conditioned on the measurement by the first probe measuring the oxygen content 129 and/or by the second probe measuring the oxygen content 136, of an oxygen content lower than a certain threshold, for example less than 2%, for example less than 0.5%, in the sweeping gas collected by the collection sub-assembly 81.

The end of the sweeping and the end of step RA3 can be conditioned on the measurement by the relative humidity probe 128 of a relative humidity lower than a certain threshold, for example less than 3%, in the sweeping gas collected by the collection sub-assembly 81.

The sweeping can for example be carried out by means of the opening of the valve 95 and/or 107A and/or 119A and/or 105 and/or 134, and/or of the tapping valve 30A of the first reservoir and/or of the tapping valve 32A of the first reservoir.

The sweeping can be carried out with the valve 107B in a closed state, to avoid the injection of inerting gas into the fluid connection means between the second reservoir 2B and the second dosing apparatus 3B.

The stopping of the sweeping and the end of step RA3 can be accompanied by the closing of the valves 102A and/or 102B and/or 102C and/or 105 and/or 134.

### Second Reservoir Replacement

The first selection step S1 can result in the selection of the second reservoir 2B. The reservoir replacement method R can then comprise a step RB1 of fluidly isolating the second reservoir 2B, subsequently to the first selection step S1.

The step RB1 of fluidly isolating the second reservoir 2B can comprise the closing of the second upstream valve 19B and/or of the second outlet valve 20B, and/or of the tapping valve 30B of the second reservoir and/or of the tapping valve 32B of the second reservoir and/or of the valve 107B.

The reservoir replacement method R can then comprise a second reservoir substitution step RB2. The step RB1 of fluidly isolating the second reservoir 2B can be followed by a second reservoir substitution step RB2.

The second reservoir substitution step RB2 can comprise the separation of the second reservoir 2B from the device, for example the separation of the connector 78B and the gas inlet tapping 29B, of the connector 87B and the gas outlet tapping 31B, and of the second duct 17B of the second reservoir 2B and the second rigid part 16B by the unlocking of the second flange 18B.

The second reservoir substitution step RB2 can comprise the withdrawal of the second reservoir 2B out of the second accommodation cradle 12B, and the deposition on the second accommodation cradle 12B of another second reservoir 2B containing a non-zero quantity of the second powder.

The second reservoir substitution step RB2 can comprise the reestablishment of the connection of the second reservoir 2B to the device, for example the connection of the connector 78B to the gas inlet tapping 29B and of the connector 87B to the gas outlet tapping 31B, and of the second duct 17B of the second reservoir 2B to the second rigid part 16B by the locking of the second flange 18B.

The reservoir replacement method R can then comprise a step RB3 of setting the content of the second reservoir. The step RB2 of substituting the second reservoir can be followed by the step RB3 of setting the content of the second reservoir.

The step RB3 of setting the content of the second reservoir can comprise the temporary sweeping using inert gas derived from the supply network 67, of the second reservoir 2B and of the fluid connection means between the second reservoir 2B and the second dosing apparatus 3B.

By “temporary”, it is meant that the sweeping begins during step RB3 and ends during step RB3.

The end of the sweeping and the end of step RB3 can be conditioned on the measurement by the first probe measuring the oxygen content 129 and/or by the second probe measuring the oxygen content 136, of an oxygen content lower than a certain threshold, for example less than 2%, for example less than 0.5%, in the sweeping gas collected by the collection sub-assembly 81.

The end of the sweeping and the end of step RB3 can be conditioned on the measurement by the relative humidity probe 128 of a relative humidity lower than a certain threshold, for example less than 3%, in the sweeping gas collected by the collection sub-assembly 81.

The sweeping can for example be carried out by means of the opening of the valve 95 and/or 107B and/or 119B and/or 105 and/or 134, and/or of the tapping valve 30B of the second reservoir and/or of the tapping valve 32B of the second reservoir.

The sweeping can be carried out with the valve 107A in a closed state, to avoid the injection of inerting gas into the fluid connection means between the first reservoir 2A and the first dosing apparatus 3A. The stopping of the sweeping and the end of step RB3 can be accompanied by the closing of the valves 102A and/or 102B and/or 102C and/or 105 and/or 134.

### Third Reservoir Replacement

The first selection step S1 can result in the selection of the third reservoir 2C. The reservoir replacement method R can then comprise a step RC1 of fluidly isolating the third reservoir 2C, subsequently to the first selection step S1.

The step RC1 of fluidly isolating the third reservoir 2C can comprise the closing of the third upstream valve 28 and/or of the third inlet valve 27C, and/or of the tapping valve 30C of the third reservoir and/or of the tapping valve 32C of the third reservoir and/or of the valve 109.

The reservoir replacement method R can then comprise a third reservoir substitution step RC2. The step RC1 of fluidly isolating the third reservoir 2C can be followed by a third reservoir substitution step RC2.

The third reservoir substitution step RC2 can comprise the separation of the third reservoir 2C of the device, for example the separation of the connector 78C and of the gas inlet tapping 29C, of the connector 87C and of the gas outlet tapping 31C, and of the third inlet duct 26C of the third reservoir 2C and of the third rigid part 24 by the unlocking of the third flange 25.

The third reservoir substitution step RC2 can comprise the withdrawal of the third reservoir 20 out of the third accommodation cradle 12C, and the deposition on the third accommodation cradle 12C of another third reservoir 2C for example not containing the powder.

The third reservoir substitution step RC2 can comprise the reestablishment of the connection of the third reservoir 2C to the device, for example the connection of the connector 78C to the gas inlet tapping 29C and of the connector 87C to the gas outlet tapping 31C, and of the third duct 26C of the third reservoir 2C to the third rigid part 24 by the locking of the third flange 25.

The reservoir replacement method R can then comprise a step RC3 of setting the content of the third reservoir. The third reservoir substitution step RC2 the can be followed by the step RC3 of setting the content of the third reservoir.

The step RC3 of setting the content of the third reservoir can comprise the temporary sweeping, using inert gas derived from the supply network 67, of the third reservoir 2C and of the fluid connection means between the third reservoir 2C and the mixer 4.

By “temporary”, it is meant that the sweeping begins during step RC3 and ends during step RC3.

The end of the sweeping and the end of step RC3 can be conditioned on the measurement by the first probe measuring the oxygen content 129 and/or by the second probe measuring the oxygen content 136, of an oxygen content lower than a certain threshold, for example less than 2%, for example less than 0.5%, in the sweeping gas collected by the collection sub-assembly 81.

The end of the sweeping and the end of step RC3 can be conditioned on the measurement by the relative humidity probe 128 of a relative humidity lower than a certain threshold, for example less than 3%, in the sweeping gas collected by the collection sub-assembly 81.

The sweeping can for example be carried out by means of the opening of the valve 95 and/or 102C and/or 109 and/or 121 and/or 105 and/or 134, and/or of the tapping valve 30C of the third reservoir and/or of the tapping valve 32C of the third reservoir.

The stopping of the sweeping and the end of step RC3 can be accompanied by the closing of the valves 102A and/or 102B and/or 102C and/or 105 and/or 134.

### Second Selection Step

The reservoir replacement method R can then comprise a second selection step S2. The step RA3 of setting the content of the first reservoir and/or the step RB3 of setting the content of the second reservoir and/or the step RC3 of setting the content of the third reservoir can be followed by the second selection step S2.

The second selection step can comprise a new implementation of the first selection step S1 if a new reservoir must be replaced. This is for example determined at the interruption I or at the first selection step S1, and for example kept in memory by the control means.

The second selection step can be followed, for example if no other reservoir needs to be replaced, by a return to the production step P1.

### Management of the Analysis Sub-Assembly 112

The obtaining method can comprise the implementation of conditional rules for the management of the opening and closing of the valves 127 and 130 monitoring the passage of gas in the second probe measuring the oxygen content 129 and in the relative humidity probe 128.

The opening of the valve 127 and of the valve 130 can for example be permitted if and only if the first probe measuring the oxygen content 136 is active and if and only if the first probe measuring the oxygen content 136 measures an oxygen content greater than an oxygen threshold, the oxygen threshold being for example equal to 2%.

The opening of the valve 134 can for example trigger the opening of the valve 127 and of the valve 130 if the opening of the valve 127 and/or of the valve 130 is not otherwise prohibited.

The valve closing 134 can for example trigger the closing of the valve 127 and of the valve 130.

The control means of the device, for example the data processing means 65, can store and implement the conditional rules, for example during the production method P, for example including the reservoir replacement method S, and/or during the content setting step B.

The detection by the first probe measuring the oxygen content 136 and/or by the second probe measuring the oxygen content 129, of an oxygen content greater than the oxygen threshold can for example trigger the securing of the device, for example by the closing of the valves 102A and/or 102B and/or 102C and/or 105 and/or 134, the stopping of the motor units 41A and/or 41B and/or 49 and/or 54, and the passage to manual monitoring by at least one operator of the device.

### Phases of Use of the Device

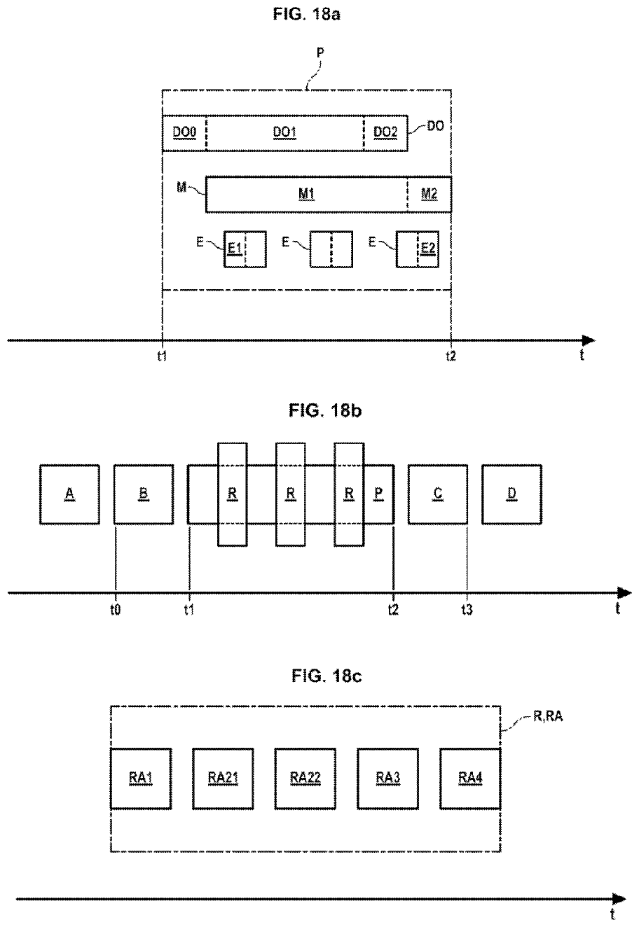

With reference to FIG. 18a, the use of the device during the obtaining method is described. In FIGS. 18a, 18b and 18c, the arrow labeled “t” represents the time axis, the time flowing in the direction of the arrow. The vertical distribution of the elements in the figure has no hierarchical, causal or chronological value and serves only to improve readability.

At the beginning of the production method P, the valves 19A, 19B, 20A, 20B, 27C and 28 can be opened to allow the circulation of the powders from the first reservoir 2A and the second reservoir 2B towards the first dosing apparatus 3A and the second dosing apparatus 3B, and from the mixer 4 to the third reservoir 2C.

The production method P can comprise an operating phase DO of the dosing apparatuses, for example the first dosing apparatus 3A and the second dosing apparatus 3B, and an operating phase of the mixer M. The beginning of the phase DO can correspond to the beginning of the production method P. The end of the phase M can correspond to the end of the production method P. The phase DO can comprise a main phase DO1 during which the first dosing apparatus 3A respectively the second dosing apparatus 3B receives the first powder, respectively the second powder, from the first reservoir 2A, respectively the second reservoir 2B, and each discharges it into the mixer 4, for example in compliance with the mixing setpoint. At the end of the main phase DO1, the valves 19A, 20A, 19B, 20B can be closed to prevent the discharge of the powders from the first reservoir 2A, respectively the second reservoir 2B towards the first dosing apparatus 3A, respectively second dosing apparatus 3B. The valve 20A can be closed before the valve 19B to prevent the retention of powder in the fluid connection element 15A. The valve 20B can be closed before the valve 19B to prevent the retention of powder in the fluid connection element 15B.

The phase M can comprise a main phase M1 during which the mixer M receives the powder from the first dosing apparatus 3A and from the second dosing apparatus 3B, and conveys it by mixing it towards the reservoir 2C into which it is discharged.

The main phases DO1 and M1 can start at the same time and take place simultaneously. The end of the phase M1 can coincide with the end of the phase DO.

The operating phase DO of the dosing apparatuses can comprise a loading phase DO0 of the dosing apparatuses, prior to DO1, during which the screws of the first dosing apparatus 3A and of the second dosing apparatus 3B are actuated independently of the mixing setpoint, to admit powder derived from the first reservoir 2A and from the second reservoir 2B, and to make it progress along the first dosing apparatus 3A and/or the second dosing apparatus 3B, to load the first dosing apparatus 3A and/or the second dosing apparatus 3B with powder. The operation of the first dosing apparatus 3A and/or of second dosing apparatus 3B is stopped before the powder discharges into the mixer 4, for example by means of a time delay.

The operating phase DO of the dosing apparatuses can comprise a final emptying phase DO2 of the dosing apparatuses, subsequent to DO1.

During the phase DO2, the dosing apparatuses discharge, in compliance with the mixing setpoints and within the limit of the quantity of powder they contain, the powder they contain into the mixer 4.

The phase DO2 can end, for example, when the first dosing apparatus 3A and/or the second dosing apparatus 3B is empty.

The operating phase of the mixer M can comprise an emptying phase of the mixer M2, subsequent to M1 and subsequent to the operating phase of the dosing apparatuses DO, during which the mixer 4 discharges the powder it contains into the third reservoir 2C, without receiving more from the first dosing apparatus 3A or the second dosing apparatus 3B.

At the end of the production method P, that is to say for example at the end of the phase M, the valves 27C and 28 can be closed between the mixer 4 and the third reservoir 2C containing the produced mixed powder. The valve 28 can be closed before the valve 27C to avoid the retention of powder in the fluid connection element 23.

For the duration of the operating phase of the mixer M, one or more sampling phases E can occur. The sampler 5 operating method E, for example a sampling phase E of the sampler 5 operating method E, can comprise the sampling step E1, for example during which the sampling screw of the sampler 5 is set in motion to take a portion of the stream of mixed powder discharged by the mixer 4 into the third reservoir 2C, and to transfer it in the sample container 6.

The sampler 5 operating method E, for example a sampling phase E of the sampler 5 operating method E, can comprise the purging step E2, subsequent to the sampling step E1, the purge comprising for example the emptying of the sampler 5, the sampling screw of the sampler 5 being for example set in motion to release towards the third reservoir C the remainder of powder it could contain following the sampling step E1.

The sampling phase(s) E of the sampler 5 operating method E do not interrupt the other operating phases of the system. Particularly, the sampling phase(s) E do not interrupt the operating phase of the mixer M or the operating phase DO of the dosing apparatuses.

The tracking of the device operations, as described above, takes place at least over the entire duration of the production method P.

During the production method P, the device is swept with the inerting gas, for example the inerting gas coming from the source 67 is continuously distributed by the distribution sub-assembly 69 in the first reservoir 2A, the second reservoir 2B, the third reservoir 2C, in the first dosing apparatus 3A, the second dosing apparatus 3B, in the fluid connection elements 15A, 15B, and 23, and in the mixer 4, and is continuously collected by the collection assembly 81 to be released at the vent 92.

Particularly, the valves 95, 102A, 102B, 102C, 105, 134 as well as 30A, 30B, 30C, 107A, 107B and 109 can be opened to allow the general circulation of the inerting gas. The valves 119A, 119B and 121 are closed to prevent the inerting gas from causing a significant stream of powder towards the outlet tappings 34A, 34B and 36 of the fluid connection means between the first reservoir 2A, respectively the second reservoir 2B, and the first dosing apparatus 3A, respectively the second dosing apparatus 3B, and between the mixer 4 and the third reservoir 2C. The valves 32A, 32B and 32C can be closed to prevent the inerting gas from training powder out of the first reservoir 2A, second reservoir 2B and third reservoir 2C.

As long as the oxygen content measured by the oxygen probe 136 is sufficiently low, for example lower than an explosiveness risk threshold, the explosiveness risk threshold being for example less than 2%, the valves 127 and 130 can be opened, to allow fine analysis of the inerting gas by the oxygen probe 128 and the humidity probe 129.

With reference to FIG. 18b, the obtaining method is described. The obtaining method can comprise the reservoir installation step A and the content setting step B subsequent to A. The production method can comprise the stopping step C, and a reservoir deposition step D subsequent to the stopping step C. The production method P is preceded by the reservoir installation step A and the content setting step B. The production method P can then begin with the stopping step C and the reservoir deposition step D. The production method P can comprise an interruption by one or more implementation(s) of the reservoir replacement method R so as to replace one or more reservoir(s). The tracking of the operations of the device as described above can be carried out at least during the entire duration of the production method P, and advantageously at least from the beginning of the content setting step B and advantageously at least until the end of the stopping step C.

The reservoir installation step A can comprise the placement of the first reservoir 2A containing the first powder, for example new powder, on the first accommodation cradle 12A. The first reservoir 2A can enclose inerting gas. The reservoir installation step A can comprise the placement of the second reservoir 2B containing the second powder, for example recycled powder, on the second accommodation cradle 12B. The second reservoir 2B can enclose inerting gas. The reservoir installation step A can comprise the placement of the third reservoir 2C, for example empty reservoir, on the third accommodation cradle 12C. The third reservoir 2A can enclose inerting gas.

The reservoir installation step A can comprise the fluid connection from the first reservoir 2A, the second reservoir 2B and the third reservoir 2C to the device, for example for the first reservoir 2A, the connection from the coupler 78A to the tapping 29A and from the coupler 87A to the tapping 31A, and from the duct 17A to the element 16A by the locking of the flange 18A, for example for the second reservoir 2B, the connection from the coupler 78B to the tapping 29B and from coupler 87B to the tapping 31B, and from the duct 17B to the element 16B by the locking of the flange 18B, for example for the third reservoir 2C, the connection from the coupler 78C to the tapping 29C and from the coupler 87C to the tapping 31C, and from the duct 26C to the element 24 by the locking of the flange 25.

The content setting step B can comprise the sweeping of the device by means of the inerting gas coming from the source 67, particularly the sweeping of the first dosing apparatus 3A, of the second dosing apparatus 3B, of the mixer 4, of the fluid connection means between the reservoir 2A and the first dosing apparatus 3A, between the second reservoir 2B and the second dosing apparatus 3B, between the third reservoir 2C and the mixer 4, and of the first reservoir 2A, of the second reservoir 2B, and of the third reservoir 2C.

The content setting step B ensures that the oxygen contents in the device are sufficiently low to eliminate the risks related to the explosiveness of the powder particles in suspension, for example, less than 2%, before the start of the production method P.

The content setting step B ensures that the oxygen and humidity contents in the device are compatible with the requirement of preserving the quality of the powders during the production method P, for example less than 1,000 ppm and less than 1%, respectively, before the start of the production step P. During the content setting step B, the valves 95, 102A, 102B, 102C, 105, 134 as well as 30A, 30B, 30C, 107A, 107B and 109 as well as 119A, 119B and 121 as well as 32A, 32B and 32C can be opened. During the content setting step B, the valves 19A, 19B, 20A, 20B, 27C and 28 can be closed on the one hand to prevent any circulation of powders, and on the other hand to obtain a more effective and safer content setting sweeping by partitioning the device.

During the content setting step B, the inerting gas continuously provided by the source 67 can be distributed in the device, continuously leading to the collection assembly 81 before being released at the vent 92. In the collection assembly 81, the valves 127 and 130 can be closed as long as the probe 136 detects an oxygen content that is insufficiently low to eliminate the risks related to the explosiveness of the particles of powder in suspension, for example, greater than 2%.

The content setting step B can end for example when the probes 136, 128 and 129 measure oxygen and humidity contents compatible with the requirements of safety and preservation of the quality of the powders.

At the end of the content setting step B, the sweeping is temporarily stopped by closing the valves 102A, 102B, 102C, 105, 127, 130 and 134 to allow the placement of the production sequence.

The stopping step C can correspond to the stopping of the sweeping with the inerting gas and to the fluid isolation of the device.

The reservoir deposition step D can comprise the fluid disconnection of the reservoirs 2A, 2B and 2C from the device, for example for the reservoir 2A, the separation of the coupler 78A and the tapping 29A, of the coupler 87A and the tapping 31A, and of the duct 17A and the element 16A by the unlocking of the flange 18A, for example for the reservoir 2B, the separation of the coupler 78A and the tapping 29A, of the coupler 87A and the tapping 31A, and of the duct 17A and the element 16A by the unlocking of the flange 18A, for example for the reservoir 2X, the separation of the coupler 78C and the tapping 29C, of the coupler 87C and the tapping 31C, and of the duct 26C and the element 24 by the unlocking of the flange 25.

The reservoir deposition step D can comprise the deposition of the first reservoir 2A from the first accommodation cradle 12A. The reservoir deposition step D can comprise the deposition of the second reservoir 2B from the second accommodation cradle 12B. The reservoir deposition step D can comprise the deposition of the third reservoir 2C from the third accommodation cradle 12C.

A sequence of the reservoir replacement method R can comprise the replacement RA of the first reservoir 2A, which comprises the replacement, during the production method P, of the first reservoir 2A, for example empty reservoir, with another first reservoir 2A containing the first powder, and/or the replacement of the second reservoir 2B, which comprises the replacement, during the production method P, of the second reservoir 2B, for example empty reservoir, with another second reservoir 2B containing the second powder, and/or the replacement of the third reservoir 20, which comprises the replacement, during the production method P, of the third reservoir 2C, for example full reservoir, with another third reservoir 2C for example empty reservoir. A sequence of the reservoir replacement method R can begin by the closing of the valves 102A, 102B, 102C, 105, 127, 130 and 134 to temporarily interrupt the sweeping with the inerting gas. Advantageously, the tracking of the operations of the device as described above is continued during the reservoir replacement method R.

With reference to FIG. 18c, the replacement RA of the first reservoir 2A is described. The replacement RA can comprise the step RA1 of fluidly isolating the first reservoir 2A, comprising for example the disconnection of the first reservoir 2A. The replacement RA can comprise the first reservoir substitution step RA2, comprising for example the replacement RA21 of the first reservoir 2A with another first reservoir 2A, for example subsequently to the step RA1 of fluidly isolating the first reservoir 2A. The first reservoir substitution step RA2 can comprise the connection RA22 of the new first reservoir 2A, subsequent to step RA2.

The replacement RA can comprise the step RA3 of setting the content of the new first reservoir 2A, for example subsequent to the phase RA2. The replacement RA can comprise the return to production RA4, for example subsequently to the step RA3.

The step RA1 can comprise the closing of the valves 19A and 20A, and of the valves 30A and 32A to fluidly isolate the first reservoir 2A. The valve 20A can be closed before the valve 19A to avoid the retention of powder in the fluid connection element 15A.

The step RA1 can comprise the disconnection of the connector 78A and the tapping 29A, the disconnection of the connector 87A and the tapping 31A, and the separation of the reservoir 2A and the element 33A by opening the flange 18A. The step RA2 of substituting the first reservoir 2A with another first reservoir 2A can comprise the deposition of the first reservoir 2A from the first cradle 12A, and the placement of the new first reservoir 2A on the first cradle 12A. The step RA2 of substituting the first reservoir 2A with another first reservoir 2A can comprise the disconnection of the connector 78A and the tapping 29A, the disconnection of the connector 87A and the tapping 31A, and the securing of the reservoir 2A and the element 33A by the locking of the flange 18A.

The step RA3 of setting the content of the new first reservoir 2A can begin with the opening of the valves 106A and 119A to allow the sweeping with the inerting gas of the fluid connection element 15A, the closing of the valve 106B to prevent the injection of inerting gas into the fluid connection element 15B, and the opening of the valve 105 to restore the circulation of the inerting gas towards the fluid connection element 15A. The inerting gas continuously sweeping the device can be collected by the collection sub-assembly 81 and released at the vent 92.

In the collection sub-assembly, the oxygen probe 136 can control the opening or closing of the valves 127 and 130 depending on whether the oxygen content measured by this probe 136 is lower or greater than a threshold, for example an explosiveness risk threshold, for example a threshold of 2% oxygen content.

The step RA3 of setting the content of the new first reservoir 2A can end when the probes 135, 128 and 129 detect oxygen and humidity contents compatible with the requirements of safety and preservation of the quality of the powders for the production phase. P. The return to production RA4 can comprise the temporary stopping of the sweeping by closing the valves 102A, 102B, 102C, 105, 127, 130 and 134, then closing the valve 119A and opening the valve 106B to restore the configuration of the production method P, then the resumption of the sweeping by re-opening the valves 102A, 102B, 102C, 105, and 134.

The replacements RB of the second reservoir 2B, and RC of the third reservoir 2C can be carried out in the same way.

1. A device for continuously mixing a first powder and a second powder, comprising:
a first continuous dosing apparatus of the first powder and a second continuous dosing apparatus of the second powder,
a mixer arranged to mix the first powder dosed by the first dosing apparatus and the second powder dosed by the second dosing apparatus so as to provide a continuous stream of powder mixed according to a determined ratio, and
a sampler adapted to take a fraction of the stream of mixed powder.

2. The device according to claim 1, wherein at least one among the first dosing apparatus and the second dosing apparatus is a gravimetric dosing apparatus.

3. The device according to claim 1, wherein at least one among the first dosing apparatus and the second dosing apparatus is a screw dosing apparatus, and/or the mixer is a screw mixer and/or the sampler is a screw sampler.

4. The device according to claim 1, further comprising at least one among a first reservoir for the first powder arranged to store the first powder and to continuously provide the first powder to the first dosing apparatus, for example by gravity, a second reservoir for the second powder arranged to store the second powder and to continuously provide the second powder to the second dosing apparatus, for example by gravity, and a third reservoir for the mixed powder arranged to receive the stream of mixed powder.

5. The device according to claim 1, wherein the device is configured to track the mixing of at least one among the first stored powder and the second stored powder to obtain the stored mixed powder.

6. The device according to claim 1, further comprising a powder and gas-tight flexible fluid connection element between the first reservoir and the first dosing apparatus and/or a powder and gas-tight flexible fluid connection element between the second reservoir and the second dosing apparatus and/or a powder and gas-tight flexible fluid connection element between the first dosing apparatus and the mixer and/or a powder and gas-tight flexible fluid connection element between the second dosing apparatus and the mixer, and/or a powder and gas-tight flexible fluid connection element between the mixer and the third reservoir.

7. The device according to claim 1, further comprising inerting means adapted to distribute an inerting gas at one or more points of the device, and adapted to collect the inerting gas at one or more points of the device.

8. The device according to claim 7, wherein the inerting means are adapted to, for example selectively, distribute the inerting gas to the, and collect the inerting gas from, at least one among a first reservoir, a second reservoir, a second reservoir, the first dosing apparatus, the second dosing apparatus, the mixer, powder and gas-tight fluid connection means between the first reservoir and the first dosing apparatus, powder and gas-tight fluid connection means between the second reservoir and the second dosing apparatus, powder and gas-tight fluid connection means between the first dosing apparatus and the mixer, powder and gas-tight fluid connection means between the second dosing apparatus and the mixer, powder and gas-tight fluid connection means between the mixer and the third reservoir.

9. The device according to claim 1, wherein the mixed powder is intended for additive manufacturing, one at least of the first powder and of the second powder being a recycled powder.

10. A method for obtaining a mixed powder, implemented by means of a device according to claim 1, the method comprising a continuous mixing of the first powder and of the second powder.
